(19) United States
(12) Patent Application Publication
(10) Pub. No.: US 2026/0332317 A1
(43) Pub. Date: Oct. 22, 2026

(54) METHOD USED IN NODE FOR WIRELESS COMMUNICATIONS, AND APPARATUS

(71) Applicant: Bunker Hill Technologies LLC, Allen, TX (US)

(72) Inventors: Jin LIU, Shanghai (CN); Xiaobo ZHANG, Shanghai (CN)

(21) Appl. No.: 19/100,467

(22) PCT Filed: Aug. 4, 2023
(86) PCT No.: PCT/CN2023/111144

§ 371 Date: Jan. 31, 2025

(30) Foreign Application Priority Data
Aug. 8, 2022 (CN) 202210945343.X

(51) Int. Cl. H04L 5/00; H04W 64/00

(52) U.S. Cl. CPC H04L 5/0005; H04W 64/00

(57) ABSTRACT

A first node sends on a first time-frequency resource block a target positioning reference signal. A first bandwidth part is provided with at least one first type of lengths and a second length, the at least one first type of lengths being used for determining from amongst a first time slot set at least one first type of time slot subset, the second length being used for determining from amongst the first time slot set a second time slot subset, a first length being a first type of length amongst the at least one first type of lengths which is used for determining the first time slot subset, and the number of symbols occupied by the target positioning reference signal in the time domain being not greater than the first length. The present application realizes a flexible resource determination method, and improves the utilization rate of effective resources.

### TECHNICAL FIELD

This application relates to a transmission method and apparatus in a wireless communications system, and in particular, to a sidelink-related transmission solution and apparatus in wireless communications.

### BACKGROUND

Starting from Long Term Evolution (LTE), 3GPP (3rd Generation Partner Project) has evolved SL (Sidelink, sidelink) as a direct communication mode between a user and a user, and a first NR SL (New Radio Sidelink, New Radio Sidelink) standard of “5G V2X with NR Sidelink” is completed in Rel-16 (Release-16, Release 16). In Rel-16, NR SL is mainly designed for V2X (Vehicle-to-Everything, Internet of Vehicles), but it can also be used for public safety. With the further enhancement of NR SL, Rel-17 introduces periodic-based partial sensing (PBPS), continuous partial sensing (CPS), random selection and discontinuous reception (DRX) power saving schemes, and also introduces inter-UE coordination schemes to provide more reliable channel resources.

In order to meet commercialized application scenarios, the industry has proposed new requirements, higher data throughput, and support for new carrier frequencies for V2X. Therefore, on the 3 GPP RAN-#94 E conference, the standardized work of NR V2X Rel-18 is formally turned on through work item description (WID) RP-213678 for NR SL evolution.

### SUMMARY OF THE DISCLOSURE

According to the work plan in RP-213588, NR Rel-18 needs to support an enhanced positioning technology of sidelink positioning (SL Positioning), where the mainstream sidelink positioning technology includes SL RTT technology, SLAP, SLTDOA, Slaod, etc. and the execution of these technologies needs to rely on measurement of SL PRS (Sidelink Positioning Reference Signal). Different from a Downlink Positioning Reference Signal (DL PRS), a resource pool for carrying the SL PRS needs to be allocated on an SLBWP (Bandwidth Part, bandwidth part). However, the existing method for determining the SL resource pool cannot meet the requirement of the SL PRS, and seriously affects the resource utilization rate of the SL.

In view of the foregoing problem, this application discloses a method for determining a resource pool for an SL PRS, to effectively improve a utilization rate of SL resources. It should be noted that, in the case of no conflict, the embodiments in the user equipment and the features in the embodiments of the present disclosure may be applied to the base station, and vice versa.

In the case of no conflict, the embodiments of the present disclosure and the features in the embodiments may be arbitrarily combined with each other. Further, although the beginner of the present application is for SL, the present application can also be used for UL (Uplink, uplink). Further, although the primary party of the present application is for single-carrier communication, the present application can also be used for multi-carrier communication.

Further, although the primary party of the present application is for single antenna communication, the present application can also be used for multi-antenna communication.

Further, although the beginner of the present application is directed to a V2X scenario, the present application is also applicable to a communication scenario between a terminal and a base station, a terminal and a relay, and between a relay and a base station, to obtain a similar technical effect in a V2X scenario. In addition, using a unified solution in different scenarios (including but not limited to a V2X scenario and a communication scenario between a terminal and a base station) helps to reduce hardware complexity and costs.

It should be noted that the explanation of terminology in this application is defined with reference to the 3 GPP specification protocol TS36 series, the TS37 series, and the TS38 series, but can also refer to the definition of the specification protocol of the Institute of Electrical and Electronics Engineers (IEEE).

The present application discloses a method in a first node for wireless communication, comprising:
Sending a target positioning reference signal on a first time-frequency resource block;
Wherein the first bandwidth component is configured with at least one first-type length and a second length; the first bandwidth component includes frequency domain resources occupied by a plurality of resource pools, and any one of the plurality of resource pools includes at least one slot in a time domain; the first slot set includes a plurality of slots, a quantity of first-type symbols included in any slot in the first slot set and the at least one first-type length are used to determine at least one first-type slot subset from the first slot set, and a quantity of first-type symbols included in any slot in the first slot set and the second length are used to determine a second slot subset from the first slot set, where the first-type symbols include at least uplink symbols; any first-type slot subset in the at least one first-type slot subset is used to determine a time-domain resource occupied by at least one resource pool in the plurality of resource pools, and the second slot subset is used to determine a time-domain resource occupied by at least one resource pool in the plurality of resource pools; the first time-frequency resource block belongs to a first resource pool, the first resource pool is one of the plurality of resource pools, the first slot subset is one of the at least one first-type slot subset, the first slot subset is used to determine a time-domain resource occupied by the first resource pool, and the first length is a first-type length in the at least one first-type length used to determine the first slot subset; a quantity of symbols occupied by the target positioning reference signal in a time domain is not greater than the first length.

In one embodiment, the problem to be solved by the present application is: the existing SL resource pool determination method cannot meet the requirement of SL PRS, and seriously affects the resource utilization rate of SL.

In one embodiment, the method of the present disclosure is to introduce a new resource determination method for an SL PRS.

In one embodiment, the method of the present disclosure is to establish a relationship between a first bandwidth component and at least one first-type length and a second length.

In one embodiment, the method of the present disclosure is to suggest a relationship between at least one first-type length and a first time-slot subset.

In one embodiment, the method of the present disclosure is to propose a relationship between at least one first-type length and a first resource pool.

In one embodiment, the above method is advantageous in that a flexible resource determination method is implemented, and the utilization rate of effective resources is improved.

According to an aspect of this application, the foregoing method is characterized in that the second slot subset is used to determine a time domain resource occupied by a second resource pool, and the second resource pool is one resource pool of the plurality of resource pools different from the first resource pool.

According to one aspect of the present disclosure, the above method is characterized in that the target positioning reference signal is used for sidelink positioning (SL positioning).

According to one aspect of the present disclosure, the above method is characterized in that the number of symbols occupied by the target positioning reference signal in the time domain is equal to the first length.

According to one aspect of the present disclosure, the above method is characterized in that the first length is not equal to the second length.

According to one aspect of the present disclosure, the above method is characterized in that the at least one first-type length and the at least one first-type bitmap are jointly used to determine the at least one first-type time slot subset.

According to an aspect of this application, the foregoing method is characterized in that the first bitmap is one of the at least one first-type bitmap, the first candidate slot is any slot in the first slot set, and a quantity of first-type symbols included in the first candidate slot is jointly used to determine whether the first candidate slot belongs to the first slot subset.

According to one aspect of the present disclosure, the above method is characterized in that the first time-frequency resource block is determined by the first node by itself from the first resource pool.

According to one aspect of the present disclosure, the above method is characterized in that the first time-frequency resource block is specified by one piece of downlink signaling from the first resource pool.

According to one aspect of the present disclosure, the above method is characterized by comprising:
Receiving first configuration information;
Wherein the first configuration information is used to configure the at least one first-type length of the first bandwidth component.

According to one aspect of the present disclosure, the above method is characterized by comprising:
Receiving second configuration information;
Wherein the second configuration information is used to configure the plurality of resource pools.

According to one aspect of the present disclosure, the above method is characterized by comprising:
Sending first control information on a second time-frequency resource block; and
Wherein the first control information is used to indicate the first time-frequency resource block, the second time-frequency resource block belongs to the first resource pool, or the second time-frequency resource block belongs to the second resource pool.

According to one aspect of the present disclosure, the above method is characterized in that the first node is a user equipment.

According to one aspect of the present disclosure, the above method is characterized in that the first node is a relay node.

According to one aspect of the present disclosure, the above method is characterized in that the first node is a base station.

The present application discloses a method in a second node for wireless communication, comprising:
Receiving a target positioning reference signal on a first time-frequency resource block; and
Wherein the first bandwidth component is configured with at least one first-type length and a second length; the first bandwidth component includes frequency domain resources occupied by a plurality of resource pools, and any one of the plurality of resource pools includes at least one slot in a time domain; the first slot set includes a plurality of slots, a quantity of first-type symbols included in any slot in the first slot set and the at least one first-type length are used to determine at least one first-type slot subset from the first slot set, and a quantity of first-type symbols included in any slot in the first slot set and the second length are used to determine a second slot subset from the first slot set, where the first-type symbols include at least uplink symbols; any first-type slot subset in the at least one first-type slot subset is used to determine a time-domain resource occupied by at least one resource pool in the plurality of resource pools, and the second slot subset is used to determine a time-domain resource occupied by at least one resource pool in the plurality of resource pools; the first time-frequency resource block belongs to a first resource pool, the first resource pool is one of the plurality of resource pools, the first slot subset is one of the at least one first-type slot subset, the first slot subset is used to determine a time-domain resource occupied by the first resource pool, and the first length is a first-type length in the at least one first-type length used to determine the first slot subset; a quantity of symbols occupied by the target positioning reference signal in a time domain is not greater than the first length.

According to an aspect of this application, the foregoing method is characterized in that the second slot subset is used to determine a time domain resource occupied by a second resource pool, and the second resource pool is one resource pool of the plurality of resource pools different from the first resource pool.

According to one aspect of the present disclosure, the above method is characterized in that the target positioning reference signal is used for sidelink positioning.

According to one aspect of the present disclosure, the above method is characterized in that the number of symbols occupied by the target positioning reference signal in the time domain is equal to the first length.

According to one aspect of the present disclosure, the above method is characterized in that the first length is not equal to the second length.

According to one aspect of the present disclosure, the above method is characterized in that the at least one first-type length and the at least one first-type bitmap are jointly used to determine the at least one first-type time slot subset.

According to an aspect of this application, the foregoing method is characterized in that the first bitmap is one of the at least one first-type bitmap, the first candidate slot is any slot in the first slot set, and a quantity of first-type symbols included in the first candidate slot is jointly used to determine whether the first candidate slot belongs to the first slot subset.

According to one aspect of the present disclosure, the above method is characterized in that the first time-frequency resource block is determined by the first node by itself from the first resource pool.

According to one aspect of the present disclosure, the above method is characterized in that the first time-frequency resource block is specified by one piece of downlink signaling from the first resource pool.

According to one aspect of the present disclosure, the above method is characterized by comprising:
Receiving first configuration information;
Wherein the first configuration information is used to configure the at least one first-type length of the first bandwidth component.

According to one aspect of the present disclosure, the above method is characterized by comprising:
Receiving second configuration information;
Wherein the second configuration information is used to configure the plurality of resource pools.

According to one aspect of the present disclosure, the above method is characterized by comprising:
Receiving first control information on a second time-frequency resource block; and
Wherein the first control information is used to indicate the first time-frequency resource block, the second time-frequency resource block belongs to the first resource pool, or the second time-frequency resource block belongs to the second resource pool.

According to one aspect of the present disclosure, the above method is characterized in that the second node is a user equipment.

According to one aspect of the present disclosure, the above method is characterized in that the second node is a relay node.

According to one aspect of the present disclosure, the above method is characterized in that the second node is a base station.

The present application discloses a method in a third node for wireless communication, comprising:
Sending first configuration information and second configuration information;
Wherein the first configuration information is used to configure at least one first-type length and a second length of the first bandwidth component; the first bandwidth component includes frequency domain resources occupied by a plurality of resource pools, and the second configuration information is used to configure the plurality of resource pools; any resource pool of the plurality of resource pools includes at least one slot in a time domain; the first slot set includes a plurality of slots, a quantity of first-type symbols included in any slot in the first slot set and the at least one first-type length are used to determine at least one first-type slot subset from the first slot set, and a quantity of first-type symbols included in any slot in the first slot set and the second length are used to determine a second slot subset from the first slot set, where the first-type symbols include at least uplink symbols; Any first-type slot subset in the at least one first-type slot subset is used to determine a time-domain resource occupied by at least one resource pool in the plurality of resource pools, and the second slot subset is used to determine a time-domain resource occupied by at least one resource pool in the plurality of resource pools.

According to one aspect of the present disclosure, the above method is characterized in that the third node is a base station.

According to one aspect of the present disclosure, the above method is characterized in that the third node is a relay node.

According to one aspect of the present disclosure, the above method is characterized in that the third node is a user equipment.

The present application discloses a first node for wireless communication, comprising:
a first transmitter, configured to send a target positioning reference signal on a first time-frequency resource block; and
The first bandwidth component is configured with at least one first-type length and a second length; the first bandwidth component includes frequency domain resources occupied by a plurality of resource pools, and any one of the plurality of resource pools includes at least one slot in a time domain; the first slot set includes a plurality of slots, a quantity of first-type symbols included in any slot in the first slot set and the at least one first-type length are used to determine at least one first-type slot subset from the first slot set, and a quantity of first-type symbols included in any slot in the first slot set and the second length are used to determine a second slot subset from the first slot set, where the first-type symbols include at least uplink symbols; any first-type slot subset in the at least one first-type slot subset is used to determine a time-domain resource occupied by at least one resource pool in the plurality of resource pools, and the second slot subset is used to determine a time-domain resource occupied by at least one resource pool in the plurality of resource pools; the first time-frequency resource block belongs to a first resource pool, the first resource pool is one of the plurality of resource pools, the first slot subset is one of the at least one first-type slot subset, the first slot subset is used to determine a time-domain resource occupied by the first resource pool, and the first length is a first-type length in the at least one first-type length used to determine the first slot subset; a quantity of symbols occupied by the target positioning reference signal in a time domain is not greater than the first length.

The present application discloses a second node for wireless communication, comprising:
a second receiver, configured to receive a target positioning reference signal on a first time-frequency resource block; and
The first bandwidth component is configured with at least one first-type length and a second length; The first bandwidth component includes frequency domain resources occupied by a plurality of resource pools, and any one of the plurality of resource pools includes at least one slot in a time domain; the first slot set includes a plurality of slots, a quantity of first-type symbols included in any slot in the first slot set and the at least one first-type length are used to determine at least one first-type slot subset from the first slot set, and a quantity of first-type symbols included in any slot in the first slot set and the second length are used to determine a second slot subset from the first slot set, where the first-type symbols include at least uplink symbols; any first-type slot subset in the at least one first-type slot subset is used to determine a time-domain resource occupied by at least one resource pool in the plurality of resource pools, and the second slot subset is used to determine a time-domain resource occupied by at least one resource pool in the plurality of resource pools; the first time-frequency resource block belongs to a first resource pool, the first resource pool is one of the plurality of resource pools, the first slot subset is one of the at least one first-type slot subset, the first slot subset is used to determine a time-domain resource occupied by the first resource pool, and the first length is a first-type length in the at least one first-type length used to determine the first slot subset; a quantity of symbols occupied by the target positioning reference signal in a time domain is not greater than the first length.

The present application discloses a third node for wireless communication, comprising:
a third transmitter, configured to send first configuration information and second configuration information;
The first configuration information is used to configure at least one first-type length and a second length of the first bandwidth component; the first bandwidth component includes frequency domain resources occupied by a plurality of resource pools, and the second configuration information is used to configure the plurality of resource pools; any resource pool of the plurality of resource pools includes at least one slot in a time domain; the first slot set includes a plurality of slots, a quantity of first-type symbols included in any slot in the first slot set and the at least one first-type length are used to determine at least one first-type slot subset from the first slot set, and a quantity of first-type symbols included in any slot in the first slot set and the second length are used to determine a second slot subset from the first slot set, where the first-type symbols include at least uplink symbols; any first-type slot subset in the at least one first-type slot subset is used to determine a time-domain resource occupied by at least one resource pool in the plurality of resource pools, and the second slot subset is used to determine a time-domain resource occupied by at least one resource pool in the plurality of resource pools.

In one embodiment, the present application has the following advantages:
The problem to be solved by the present application is: the existing method for determining the SL resource pool cannot meet the requirement of the SL PRS, and seriously affects the resource utilization rate of the SL.

The present application introduces a new resource determination method for an SL PRS.

The present application establishes a relationship between the first bandwidth component and the at least one first-type length and the second length.

In this application, the at least one first-type length is recommended to the first slot subset.

In this application, the at least one first-type length is in a suggestion relationship with the first resource pool.

In this application, a flexible resource determination method is implemented, to improve a utilization rate of valid resources.

### BRIEF DESCRIPTION OF THE DRAWINGS

Other features, objects, and advantages of the present disclosure will become more apparent upon reading the detailed description of non-limiting embodiments with reference to the following drawings:

FIG. 1 illustrates a flowchart of processing a first node according to an embodiment of the present disclosure;

FIG. 2 is a schematic diagram of a network architecture according to an embodiment of this application;

FIG. 3 illustrates a schematic diagram of a radio protocol architecture of a user plane and a control plane according to an embodiment of the present disclosure;

FIG. 4 illustrates a schematic diagram of a first communication device and a second communication device according to one embodiment of the present disclosure;

FIG. 5 illustrates a flowchart of wireless signal transmission according to an embodiment of the present disclosure;

FIG. 6 is a schematic diagram of a relationship between a first slot set and a first-type slot subset and a second slot subset according to an embodiment of this application;

FIG. 7 illustrates a schematic diagram of a relationship between a first slot subset, a second slot subset and a first resource pool according to one embodiment of the present disclosure;

FIG. 8 is a schematic diagram of a relationship between a first candidate slot, a first bitmap, and a first slot subset according to an embodiment of this application;

FIG. 9 illustrates a structural block diagram of a processing apparatus in a first node according to an embodiment of the present disclosure;

FIG. 10 shows a structural block diagram of a processing apparatus in a second node according to an embodiment of the present disclosure.

### DETAILED DESCRIPTION OF THE EMBODIMENTS

The technical solutions of the present application will be further described in detail below with reference to the accompanying drawings, and it should be noted that, in the case of no conflict, the embodiments of the present application and the features in the embodiments may be arbitrarily combined with each other.

### Example 1

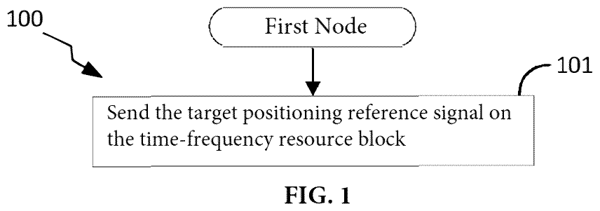

Embodiment 1 illustrates a flowchart of processing a first node according to an embodiment of this application, as shown in FIG. 1. In FIG. 1, each block represents a step.

In Embodiment 1, the first node in this application performs step 101, and sends a target positioning reference signal on a first time-frequency resource block; the first bandwidth component is configured with at least one first-type length and a second length; the first bandwidth component includes frequency domain resources occupied by a plurality of resource pools, and any one of the plurality of resource pools includes at least one slot in a time domain; the first slot set includes a plurality of slots, a quantity of first-type symbols included in any slot in the first slot set and the at least one first-type length are used to determine at least one first-type slot subset from the first slot set, and a quantity of first-type symbols included in any slot in the first slot set and the second length are used to determine a second slot subset from the first slot set, where the first-type symbols include at least uplink symbols; any first-type slot subset in the at least one first-type slot subset is used to determine a time-domain resource occupied by at least one resource pool in the plurality of resource pools, and the second slot subset is used to determine a time-domain resource occupied by at least one resource pool in the plurality of resource pools; the first time-frequency resource block belongs to a first resource pool, the first resource pool is one of the plurality of resource pools, the first slot subset is one of the at least one first-type slot subset, the first slot subset is used to determine a time-domain resource occupied by the first resource pool, and the first length is a first-type length in the at least one first-type length used to determine the first slot subset; a quantity of symbols occupied by the target positioning reference signal in a time domain is not greater than the first length.

In one embodiment, the first bandwidth part is a continuous bandwidth in a Carrier Frequency (Carrier Frequency).

In one embodiment, the first bandwidth part is a continuous frequency-domain resource in a carrier frequency.

In one embodiment, a frequency-domain resource occupied by the first bandwidth part is within a carrier frequency.

In one embodiment, the first bandwidth part comprises a plurality of subcarriers, and the plurality of subcarriers included in the first bandwidth part belong to a same carrier frequency.

In one embodiment, the first bandwidth part comprises a plurality of subcarriers, and the plurality of subcarriers included in the first bandwidth part are continuous.

In one embodiment, the first bandwidth part comprises a plurality of subcarriers, and subcarrier spacing of any two of the plurality of subcarriers included in the first bandwidth part is equal.

In one embodiment, the first bandwidth part comprises at least one Physical Resource Block (PRB).

In one embodiment, any one of the first bandwidth parts comprises a plurality of subcarriers.

In one embodiment, the first bandwidth part comprises at least one subchannel.

In one embodiment, any of the first bandwidth parts comprises a plurality of physical resource blocks.

In one embodiment, the first bandwidth part is used for sidelink communication.

In one embodiment, the first bandwidth part is used for sidelink transmission and sidelink reception.

In one embodiment, the first bandwidth part is used to carry an SL-SSB (SL-SS PSBCH Block, a Sidelink Synchronization Signal/Physical Sidelink Broadcast Channel Block, a sidelink synchronization signal/physical sidelink broadcast channel block).

In one embodiment, the first bandwidth part is used to carry SCI (Sidelink Control Information).

In one embodiment, the first bandwidth part is used for carrying a Sidelink Shared Channel (SL-SCH).

In one embodiment, the first bandwidth part is used for carrying SL HARQ (Sidelink Hybrid Automatic Repeat reQuest, Sidelink Hybrid Automatic Repeat Request) information.

In one embodiment, the first bandwidth part is used to carry an SL PTRS (Sidelink Phase Tracking Reference Signal, Sidelink Phase Tracking Reference Signal).

In one embodiment, the first bandwidth part is used for carrying a Sidelink Positioning Reference Signal (SL PRS).

In one embodiment, the first bandwidth part is used to carry an SL CSI-RS (Sidelink Channel Status Information Reference Signal, Sidelink Channel State Information Reference Signal).

In one embodiment, the first bandwidth part is used to carry a Physical Sidelink Control Channel Reference Signal (PSCCH/DMRS).

In one embodiment, the first bandwidth part is used for carrying a Physical Sidelink Shared Channel (PSSCH) DMRS.

In one embodiment, the first bandwidth part is a Bandwidth Part (BWP).

In one embodiment, see section 6.3 of 3 GPP TS 38.331 for the definition of the BWP. 2.

In one embodiment, the first bandwidth part is an SL BWP (a sidelink bandwidth part).

In one embodiment, the definition of the SLBWP refers to section 6.3 of 3 GPP TS 38.331.5.

In one embodiment, the first bandwidth part is configured with the at least one first-type length.

In one embodiment, the first bandwidth part being configured with the at least one first-type length means that the first bandwidth part is associated with the at least one first-type length.

In one embodiment, the first bandwidth part being configured with the at least one first-type length means that a parameter of the first bandwidth part comprises the at least one first-type length.

In one embodiment, any of the at least one first-type length is a number of symbols used for a sidelink in a slot.

In one embodiment, any of the at least one first-type length is a number of symbols used for sidelink positioning in a slot.

In one embodiment, at least one first-type length of the at least one first-type length is a number of symbols used for the sidelink positioning reference signal in one slot.

In one embodiment, at least one of the at least one first-type length is a number of symbols used for a sidelink in a slot without an SL-SSB.

In one embodiment, at least one first-type length of the at least one first-type length is a number of symbols used for an SL PRS in one slot.

In one embodiment, any of the at least one first-type length is a positive integer.

In one embodiment, the at least one first-type length comprises at least one of four symbols, six symbols, eight symbols, and 14 symbols.

In one embodiment, the at least one first-type length comprises at least one of 4, 6, 8 and 14.

In one embodiment, one of the at least one first-type length is four symbols.

In one embodiment, one of the at least one first-type length is 6 symbols.

In one embodiment, one of the at least one first-type length is 8 symbols.

In one embodiment, one of the at least one first-type length is 14 symbols.

In one embodiment, one of the at least one first-type length is 4.

In one embodiment, one of the at least one first-type length is 6.

In one embodiment, one of the at least one first-type length is 8.

In one embodiment, one of the at least one first-type length is 14.

In one embodiment, the at least one first-type length is configured by an RRC i.e. (Radio Resource Control Information Element, Radio Resource Control Information Element).

In one embodiment, the at least one first-type length is configured by an SL-BWP-Config.

In one embodiment, the definition of the SL-BWP-Config refers to section 6.3 of 3 GPP TS 38.331.5.

In one embodiment, the first bandwidth part is configured with the at least one first-type length and the second length.

In one embodiment, the first bandwidth part being configured with the at least one first-type length and the second length means that the first bandwidth part is associated with the at least one first-type length and the second length.

In one embodiment, the first bandwidth part being configured with the at least one first-type length and the second length means that a parameter of the first bandwidth part comprises the at least one first-type length and the second length.

In one embodiment, the second length is a number of symbols used for a sidelink in a slot.

In one embodiment, the second length is a number of symbols used for sidelink communication in a slot.

In one embodiment, the second length is a number of symbols used for a sidelink in a slot without SL-SSB.

In one embodiment, the second length is a number of symbols used for a PSCCH and a PSSCH in a slot.

In one embodiment, the second length is a number of symbols used for a PSCCH, a PSSCH and a PSFCH in one slot.

In one embodiment, the second length is a positive integer.

In one embodiment, the second length is one of 7 symbols, 8 symbols, 9 symbols, 10 symbols, 11 symbols, 12 symbols, 13 symbols, and 14 symbols.

In one embodiment, the second length is one of 7, 8, 9, 10, 11, 12, 13, and 14.

In one embodiment, the second length is 7 symbols.

In one embodiment, the second length is 8 symbols.

In one embodiment, the second length is 12 symbols.

In one embodiment, the second length is 14 symbols.

In one embodiment, the second length is 7.

In one embodiment, the second length is 8.

In one embodiment, the second length is 12.

In one embodiment, the second length is 14.

In one embodiment, the second length is configured by an RRC i.e.

In one embodiment, the at least one first-type length and the second length are both configured by an SL-BWP-Config.

In one embodiment, the second length is not equal to any one of the at least one first-type length.

In one embodiment, the second length is not less than any of the at least one first-type length.

In one embodiment, the second length is greater than any one of the at least one first-type length.

In one embodiment, the second length is equal to one of the at least one first-type length.

In one embodiment, the second length is less than one of the at least one first-type length.

In one embodiment, any two first-type lengths of the at least one first-type length are different.

In one embodiment, the first length is one of the at least one first-type length.

In one embodiment, the first length is unequal to the second length.

In one embodiment, the first length is not greater than the second length.

In one embodiment, the first length is less than the second length.

In one embodiment, the first length is equal to the second length.

In one embodiment, the first length is greater than the second length.

In one embodiment, the first length is 4, and the second length is 7.

In one embodiment, the first length is 14, and the second length is 8.

In one embodiment, the first length is 4 symbols, and the second length is 7 symbols.

In one embodiment, the first length is 14 symbols, and the second length is 8 symbols.

In one embodiment, a slot is a time unit.

In one embodiment, a slot is a time-domain resource.

In one embodiment, a symbol is a time unit.

In one embodiment, a symbol is a time-domain resource.

In one embodiment, the one slot comprises at least one symbol.

In one embodiment, the one slot comprises a plurality of symbols.

In one embodiment, any symbol in the one slot is one of a first-type symbol or a second-type symbol.

In one embodiment, the one slot comprises at least one first-type symbol and at least one second-type symbol.

In one embodiment, any symbol in the one slot is a first-type symbol.

In one embodiment, any symbol in the one slot is a second-type symbol.

In one embodiment, the first-type symbol comprises at least the former of both an uplink symbol and a Flexible Symbol.

In one embodiment, the first-type symbol is an uplink symbol.

In one embodiment, the first-type symbol is a symbol semi-statically configured to uplink.

In one embodiment, the first-type symbol is a semi-statically configured uplink symbol in a slot.

In one embodiment, the second-type symbol comprises at least one of a Downlink Symbol Number and a Flexible Symbol.

In one embodiment, the second-type symbol is a downlink symbol.

In one embodiment, the second-type symbol is a flexible symbol.

In one embodiment, any symbol in the one slot is a multicarrier symbol.

In one embodiment, any symbol in the one slot is an Orthogonal Frequency Division Multiplexing (OFDM) symbol.

In one embodiment, the multicarrier symbol is a Single-Carrier Frequency Division Multiple Access (SC-FDMA) symbol.

In one embodiment, the multicarrier symbol is a Discrete Fourier Transform Spread Orthogonal Frequency Division Multiplexing (DFT-S-OFDM) symbol.

In one embodiment, the multicarrier symbol is an Orthogonal Frequency Division Multiplexing (OFDM) symbol.

In one embodiment, the multicarrier symbol is a Frequency Division Multiple Access (FDMA) symbol.

In one embodiment, the multicarrier symbol is a Filter Bank Multi-Carrier (FBMC) symbol.

In one embodiment, the multicarrier symbol is an Interleaved Frequency Division Multiple Access (IFDMA) symbol.

In one embodiment, the first bandwidth part comprises frequency domain resources occupied by a plurality of resource pools.

In one embodiment, frequency domain resources occupied by the plurality of resource pools belong to the first bandwidth part.

In one embodiment, any of the plurality of resource pools is a Sidelink Resource Pool (Sidelink Resource Pool).

In one embodiment, any of the plurality of resource pools comprises all or part of resources of a sidelink resource pool.

In one embodiment, any resource pool of the plurality of resource pools comprises at least one time slot in a time domain.

In one embodiment, any resource pool of the plurality of resource pools comprises a plurality of time slots in a time domain.

In one embodiment, any one of the plurality of resource pools comprises a plurality of symbols in any time slot in a time domain.

In one embodiment, any one of the plurality of resource pools comprises a plurality of first-type symbols in any time slot in a time domain.

In one embodiment, a time-domain resource occupied by any one of the plurality of resource pools comprises at least one time slot.

In one embodiment, a time-domain resource occupied by any one of the plurality of resource pools comprises a plurality of time slots.

In one embodiment, any time slot in a time-domain resource occupied by any one of the plurality of resource pools comprises a plurality of symbols.

In one embodiment, any one of time-domain resources occupied by any one of the plurality of resource pools comprises a plurality of first-type symbols.

In one embodiment, any of the plurality of resource pools comprises a plurality of physical resource blocks in a frequency domain.

In one embodiment, any one of the plurality of resource pools comprises a plurality of subcarriers in any physical resource block in a frequency domain.

In one embodiment, any of the plurality of resource pools comprises a plurality of sub-channels in a frequency domain.

In one embodiment, any sub-channel of any one of the plurality of resource pools in a frequency domain comprises a plurality of physical resource blocks.

In one embodiment, a frequency-domain resource occupied by any one of the plurality of resource pools comprises a plurality of physical resource blocks.

In one embodiment, any one of frequency-domain resources occupied by any one of the plurality of resource pools comprises a plurality of subcarriers.

In one embodiment, a frequency-domain resource occupied by any one of the plurality of resource pools comprises a plurality of sub-channels.

In one embodiment, any of frequency-domain resources occupied by any one of the plurality of resource pools comprises a plurality of physical resource blocks.

In one embodiment, the plurality of resource pools comprise a plurality of sub-channels in a frequency domain.

In one embodiment, the plurality of resource pools comprises a plurality of physical resource blocks in a frequency domain.

In one embodiment, the plurality of resource pools comprises a plurality of subcarriers in a frequency domain.

In one embodiment, the frequency-domain resources occupied by the plurality of resource pools comprise a plurality of sub-channels.

In one embodiment, the frequency-domain resources occupied by the plurality of resource pools comprise a plurality of physical resource blocks.

In one embodiment, the frequency-domain resources occupied by the plurality of resource pools comprise a plurality of subcarriers.

In one embodiment, any of the plurality of resource pools comprises a plurality of time-frequency resource blocks.

In one embodiment, any time-frequency resource block in any one of the plurality of resource pools comprises a plurality of symbols in a time domain.

In one embodiment, a time-domain resource occupied by any time-frequency resource block in any one of the plurality of resource pools comprises a plurality of symbols.

In one embodiment, a time-domain resource occupied by any time-frequency resource block in any one of the plurality of resource pools belongs to one time slot.

In one embodiment, any time-frequency resource block in any one of the plurality of resource pools comprises a plurality of subcarriers in a frequency domain.

In one embodiment, any time-frequency resource block in any one of the plurality of resource pools comprises at least one physical resource block in a frequency domain.

In one embodiment, any time-frequency resource block in any one of the plurality of resource pools comprises at least one sub-channel in a frequency domain.

In one embodiment, a frequency-domain resource occupied by any time-frequency resource block in any one of the plurality of resource pools comprises a plurality of subcarriers.

In one embodiment, a frequency-domain resource occupied by any time-frequency resource block in any one of the plurality of resource pools comprises at least one physical resource block.

In one embodiment, a frequency-domain resource occupied by any time-frequency resource block in any one of the plurality of resource pools comprises at least one sub-channel.

In one embodiment, a frequency-domain resource occupied by any time-frequency resource block in any one of the plurality of resource pools belongs to a sub-channel.

In one embodiment, at least one of the plurality of resource pools comprises a PSCCH.

In one embodiment, at least one of the plurality of resource pools comprises a PSSCH.

In one embodiment, at least one of the plurality of resource pools comprises a PSFCH.

In one embodiment, at least one of the plurality of resource pools comprises a PSCCH and a PSSCH.

In one embodiment, at least one of the plurality of resource pools comprises a PSCCH, a PSSCH, and a PSFCH.

In one embodiment, at least one time-frequency resource block in one of the plurality of resource pools is used to carry an SL PRS.

In one embodiment, the target positioning reference signal is used for sidelink positioning (SL Positioning).

In one embodiment, the target positioning reference signal is used to obtain an absolute position (Absolute Position).

In one embodiment, the target positioning reference signal is used to obtain a relative position (Relative Position).

In one embodiment, the target positioning reference signal is used to obtain a distance.

In one embodiment, the target positioning reference signal is used to obtain a range.

In one embodiment, the target positioning reference signal is a Positioning Reference Signal (PRS).

In one embodiment, the target positioning reference signal is an SL PRS.

In one embodiment, the target positioning reference signal comprises at least one of SL PRS, SL PTRS, SL CSI-RS, PSCCH DMRS, PSSCH DMRS, and SL-SSB.

In one embodiment, the target positioning reference signal comprises an SL PRS.

In one embodiment, the target positioning reference signal comprises an SL SSB.

In one embodiment, the target positioning reference signal comprises an SL PTRS.

In one embodiment, the target positioning reference signal comprises an SL CSI-RS.

In one embodiment, the target positioning reference signal comprises a first sequence.

In one embodiment, the first sequence is used to generate the target positioning reference signal.

In one embodiment, the first sequence is a Pseudo-Random Sequence (Pseudo-Random Sequence).

In one embodiment, the first sequence is a Low-PAPR Sequence (Low-PAPR Sequence, Low-Peak to Average Power Ratio Sequence).

In one embodiment, the first sequence is a Gold sequence.

In one embodiment, the first sequence is an M sequence.

In one embodiment, the first sequence is a Zadeoff-Chu (ZC) sequence.

In one embodiment, the first sequence is a Sequence Generation (Sequence Generation), a Physical Resource Mapping (Mapping to Physical Resources), and a Mapping to Slots (Mapping to Slots) to obtain the target positioning reference signal.

In one embodiment, a time-domain resource occupied by the target positioning reference signal comprises at least one symbol.

In one embodiment, the target positioning reference signal occupies at least one symbol in a time domain.

In one embodiment, a time-domain resource occupied by the target positioning reference signal comprises at least one symbol in a slot.

In one embodiment, the target positioning reference signal occupies at least one symbol in a time slot in a time domain.

In one embodiment, a time-domain resource occupied by the target positioning reference signal comprises a plurality of symbols.

In one embodiment, the target positioning reference signal occupies a plurality of symbols in a time domain.

In one embodiment, a time-domain resource occupied by the target positioning reference signal comprises a plurality of symbols in a slot.

In one embodiment, the target positioning reference signal occupies a plurality of symbols in a time slot in a time domain.

In one embodiment, a number of symbols occupied by the target positioning reference signal in a time domain is not greater than the first length.

In one embodiment, a number of symbols occupied by the target positioning reference signal in a time domain is less than the first length.

In one embodiment, a number of symbols occupied by the target positioning reference signal in a time domain is equal to the first length.

### Example 2

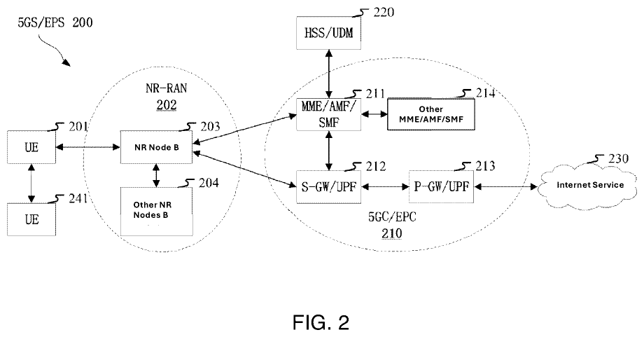

Embodiment 2 illustrates a schematic diagram of a network architecture according to the present disclosure, as shown in FIG. 2. FIG. 2 illustrates a diagram of a network architecture 200 of 5G NR, Long-Term Evolution (LTE) and Long-Term Evolution Advanced (LTE-A) systems. The 5G NR or LTE network architecture 200 May be referred to as a 5 GS (5G System)/Evolved Packet System (EPS) 200 some other suitable terminology. The 5 GS EPS 200 May include one or more User Equipment (UE) 201, a UE 241 for sidelink communication with the UE 201, an NG-RAN (Next Generation Radio Access Network) 202, a 5 GC (5G Core Network, 5G Core Network)/EPC (Evolved Packet Core) 210, an HSS (Home Subscriber Server)/UDM (Unified Data Management) 220, and an Internet service 230 The 5 GS EPS may be interconnected with other access networks, but these entities/interfaces are not shown for simplicity. As shown, 5 GS EPS provides packet-switched services, however, those skilled in the art will readily appreciate that the various concepts presented throughout this application may be extended to networks or other cellular networks that provide circuit-switched services. The NG-RAN includes an NR Node B (G 1) 203 and other GDUs 204 The graceful 203 provides termination of the user and control plane protocol towards the UE 201. The graceful 203 May be connected to other GDUs 204 via an Xn interface (e.g. backhaul) The GRUB 203 May also be referred to as a base station, a base transceiver station, a radio base station, a radio transceiver, a transceiver function, a basic service set (BSS), an extended service set (ESS), a TRP (transmit receive node), or some other suitable terminology. In an NTN network, an example of a gNB 203 includes a satellite, an aircraft, or a terrestrial base station relayed through a satellite. The gNB 203 provides the UE 201 with an access point to the 5 GC/EPC 210. Examples of UE 201 include cellular telephones, smart phones, session initiation protocol (SIP) phones, laptop computers, personal digital assistants (PDAs), satellite radios, non-terrestrial base station communications, satellite mobile communications, global positioning systems, multimedia devices, video devices, digital audio players (e.g. MP3 players), cameras, game consoles, unmanned aerial vehicles, aircraft, narrowband Internet of Things devices, machine type communications devices, land vehicles, automobiles, wearable devices, or any other similar functional device. A person skilled in the art may also refer to UE 201 as a mobile station, subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other suitable terminology. The gNB 203 is connected to the 5 GC/EPC 210.5 GC/EPC 210 through an S1/NG interface, and includes an MME (Mobility Management Entity)/AMF (Authentication Management Field)/SMF (Session Management Function) 211, another MME/AMF/SMF214, an S-GW (Service Gateway)/UPF (User Plane Function) 212, and a P-GW (Packet Date Network Gateway)/UPF 213 MME/AMF/SMF211 are control nodes for processing signaling between the UE 201 and the 5 GC/EPC 210. Generally, the MME/AMF/SMF211 provides bearer and connection management. All User IP (Internet Protocol) packets are transmitted through the S-GW/UPF 212, and the S-GW/UPF 212 itself is connected to the P-GW/UPF 213 P-GW to provide UE IP address allocation and other functions. The P-GW/UPF 213 is connected to the Internet service 230, which includes an Internet Protocol service corresponding to the operator, and may specifically include the Internet, an intranet, an IP Multimedia Subsystem (IMS), and a packet-switched streaming service.

In one embodiment, a first node in the present disclosure comprises the UE 201.

In one embodiment, a second node in the present disclosure comprises the UE 241.

In one embodiment, a third node in the present disclosure comprises the gNB 203.

In one embodiment, a user equipment in the present disclosure includes the UE 201.

In one embodiment, the user equipment in the present disclosure includes the UE 241.

In one embodiment, the base station in the present disclosure comprises the gNB 203.

In one embodiment, the relay node in the present disclosure includes the gNB 203.

In one embodiment, a transmitter of a target positioning reference signal in the present disclosure includes the UE 201.

In one embodiment, a receiver of a target positioning reference signal in the present disclosure includes the UE 241.

In one embodiment, a transmitter of first control information in the present disclosure includes the UE 201.

In one embodiment, a receiver of the first control information in the present disclosure includes the UE 241.

In one embodiment, a receiver of the first configuration information in the present disclosure includes the UE 201.

In one embodiment, a transmitter of first configuration information in the present disclosure includes the UE 201.

In one embodiment, a transmitter of first configuration information in the present disclosure includes the gNB 203.

In one embodiment, a receiver of second configuration information in the present disclosure includes the UE 201.

In one embodiment, a transmitter of second configuration information in the present disclosure includes the UE 201.

In one embodiment, a transmitter of second configuration information in the present disclosure includes the gNB 203.

### Example 3

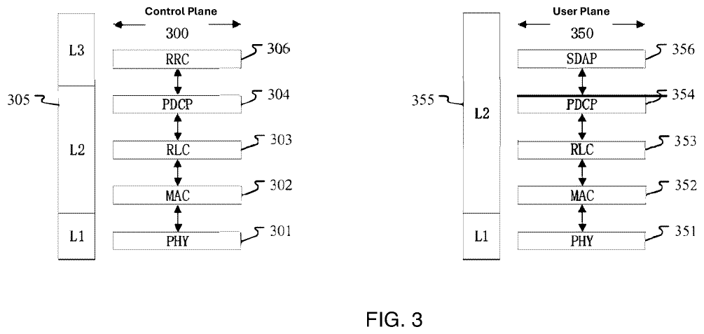

Embodiment 3 shows a schematic diagram of an embodiment of a radio protocol architecture of a user plane and a control plane according to the present disclosure, as shown in FIG. 3. FIG. 3 is a schematic diagram illustrating an embodiment of a radio protocol architecture for a user plane 350 and a control plane 300, and FIG. 3 shows, with three layers, a radio protocol architecture for a first node device (RSU, on-board device or in-vehicle communication module in a UE or V2X) and a second node device (RSU, on-board device, or on-board communication module in V2X), or a control plane 300 between two UEs: layer 1, layer 2, and layer 3 Layer 1 (L1 layer) is the lowest layer and performs various PHY (physical layer) signal processing functions. The L1 layer will be referred to herein as PHY 301 layer 2 (L2 layer) 305 over PHY 301, and is responsible for the link between the first node device and the second node device and between the two UEs through PHY 301. The L2 layer 305 includes a Medium Access Control (MAC) sublayer 302, a Radio Link Control (RLC) sublayer 303, and a Packet Data Convergence Protocol (PDCP) sublayer 304. The PDCP sublayer 304 provides data encryption and integrity protection, and the PDCP sublayer 304 further provides handover support of the first node device to the second node device. The RLC sublayer 303 provides segmentation and reassembly of data packets, retransmission of a lost data packet is achieved through ARQ, and the RLC sublayer 303 further provides repeated data packet detection and protocol error detection. The MAC sublayer 302 provides the multiplexing of mapping and logical channels between the logical and transport channels. The MAC sublayer 302 is also responsible for allocating various radio resources (e.g. resource blocks) in a cell between the first node devices. The MAC sublayer 302 is also responsible for HARQ operations. The RRC sublayer 306 in the layer 3 (L3 layer) in the control plane 300 is responsible for obtaining radio resources (i.e. radio bearers) and configuring the lower layer using RRC signaling between the second node device and the first node device. The radio protocol architecture of the user plane 350 includes a layer 1 (L1 layer) and a layer 2 (L2 layer) in which the radio protocol architecture for the first node device and the second node device is substantially the same for the PDCP sublayer 354 in the physical layer 351, the L2 layer 355, and the MAC sublayer 352 in the L2 layer 355 and the corresponding layer and sublayer in the control plane 300, but the PDCP sublayer 354 also provides header compression for the upper layer packet to reduce wireless transmission overhead. The L2 layer 355 in the user plane 350 further includes a Service Data Adaptation Protocol (SDAP) sublayer 356, and the SDAP sublayer 356 is responsible for mapping between a QoS flow and a data radio bearer (DRB) to support service diversity. Although not shown, a first node device may have several upper layers above L2 layer 355, including a network layer (e.g. an IP layer) terminating at a P-GW on a network side and an application layer terminating at another end of the connection (e.g. remote UE, server, etc.).

In one embodiment, the radio protocol architecture in FIG. 3 is applicable to the first node in the present disclosure.

In one embodiment, the radio protocol architecture in FIG. 3 is applicable to the second node in the present disclosure.

In one embodiment, the target positioning reference signal in the present disclosure is generated by the PHY 301.

In one embodiment, the first control information in the present disclosure is generated by the PHY 301.

In one embodiment, the first control information in the present disclosure is generated by the MAC sublayer 302.

In one embodiment, the first control information in the present disclosure is transmitted to the PHY 301 via the MAC sublayer 302.

In one embodiment, the first configuration information in the present disclosure is generated by the RRC sublayer 306.

In one embodiment, the first configuration information in the present disclosure is transmitted to the PHY 301 via the MAC sublayer 302.

In one embodiment, the second configuration information in the present disclosure is generated by the RRC sublayer 306.

In one embodiment, the second configuration information in the present disclosure is transmitted to the PHY 301 via the MAC sublayer 302.

### Example 4

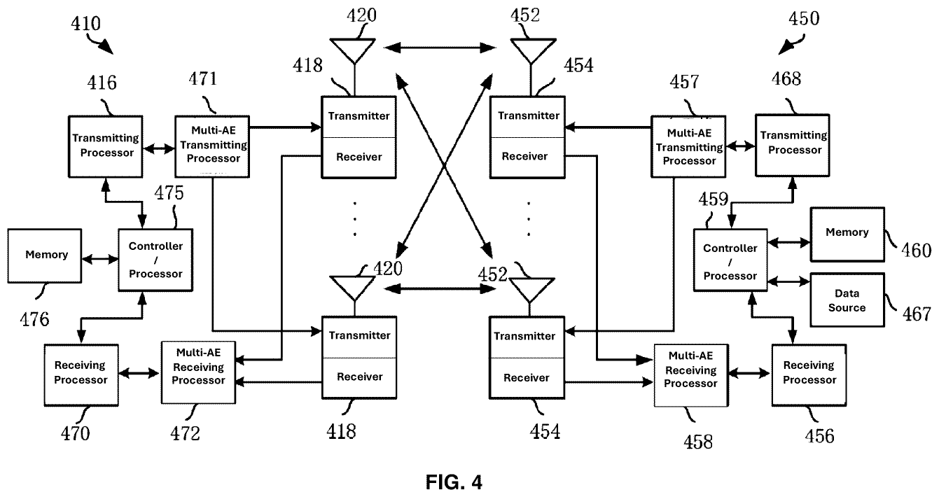

Embodiment 4 shows a schematic diagram of a first communication device and a second communication device according to the present disclosure, as shown in FIG. 4. FIG. 4 is a block diagram of a first communication device 410 and a second communication device 450 in communication with each other in an access network.

The first communication device 410 includes a controller/processor 475, a memory 476, a receiving processor 470, a transmitting processor 416, a multi-antenna receiving processor 472, a multi-antenna transmitting processor 471, a transmitter/receiver 418, and an antenna 420.

The second communication device 450 includes a controller/processor 459, a memory 460, a data source 467, a transmitting processor 468, a receiving processor 456, a multi-antenna transmitting processor 457, a multi-antenna receiving processor 458, a transmitter/receiver 454, and an antenna 452.

In the transmission from the first communication device 410 to the second communication device 450, at the first communication device 410, an upper layer data packet from the core network is provided to the controller/processor 475 controller/processor 475 to implement the functionality of the L2 layer. In the transmission from the first communication device 410 to the first communication device 450, the controller/processor 475 provides header compression, encryption, packet segmentation and reordering, multiplexing between the logic and the transport channel, and radio resource allocation for the second communication device 450 based on various priority metrics. The controller/processor 475 is also responsible for retransmission of a lost packet and signaling to the second communication device 450. The transmit processor 416 and the multi-antenna transmit processor 471 perform various signal processing functions for the L1 layer (that is, the physical layer). Transmit processor 416 performs encoding and interleaving to facilitate forward error correction (FEC) at the second communication device 450, and mapping of signal clusters based on various modulation schemes (e.g. binary phase shift keying (BPSK), quadrature phase shift keying (QPSK), M-phase shift keying (M-PSK), M quadrature amplitude modulation (M-QAM)). The multi-antenna transmitting processor 471 performs digital spatial precoding on the encoded and modulated symbols, including codebook-based precoding and non-codebook-based precoding and beamforming processing, to generate one or more spatial streams. Transmit processor 416 then maps each spatial stream to a subcarrier, multiplexes with a reference signal (e.g. pilot) in the time domain and/or frequency domain, and then uses an inverse fast Fourier transform (IFFT) to generate a physical channel that carries the time domain multicarrier symbol stream. Then, the multi-antenna transmitting processor 471 performs transmission analog precoding/beamforming on the time domain multi-carrier symbol stream. Each transmitter 418 converts the baseband multicarrier symbol stream provided by the multi-antenna transmitting processor 471 into a radio frequency stream, which is then provided to a different antenna 420.

In the transmission from the first communication device 410 to the second communication device 450, at the second communication device 450, each receiver 454 receives a signal through its respective antenna 452. Each receiver 454 recovers information modulated onto a radio frequency carrier, and converts the radio frequency stream into a baseband multicarrier symbol stream, and provides various signal processing functions for implementing the LI layer by the receiving processor 456 and the multi-antenna receiving processor 458. The multi-antenna receiving processor 458 performs reception analog precoding/beamforming on the baseband multicarrier symbol stream from the receiver 454. The receiving processor 456 converts the baseband multicarrier symbol stream after receiving the analog precoding/beamforming operation from the time domain to the frequency domain using a Fast Fourier Transform (FFT). In the frequency domain, the physical layer data signal and the reference signal are demultiplexed by the receiving processor 456, wherein the reference signal is used for channel estimation, and the data signal recovers any spatial stream destined for the second communication device 450 after multi-antenna detection in the multi-antenna receiving processor 458. The symbols on each spatial stream are demodulated and recovered in the receive processor 456 and a soft decision is generated. The receiving processor 456 then decodes and de-interleaves the soft decision to recover upper layer data and control signals transmitted on the physical channel by the first communication device 410. The upper layer data and control signals are then provided to the controller/processor 459 controller/processor 459 to implement the functions of the L2 layer. The controller/processor 459 can be associated with a memory 460 that stores program code and data. The memory 460 May be referred to as a computer-readable medium. In the transmission from the first communication device 410 to the second communication device 450, the controller/processor 459 provides demultiplexing between transport and logical channels, packet reassembly, deciphering, header decompression, control signal processing to recover upper layer data packets from the core network. The upper layer data packet is then provided to all protocol layers above the L2 layer. Various control signals may also be provided to L3 for L3 processing.

In the transmission from the second communication device 450 to the first communication device 410, at the second communication device 450, a data source 467 is used to provide an upper layer data packet to the controller/processor 459 data source 467 representing all protocol layers above the L2 layer. Similar to the transmission function at the first communication device 410 described in the transmission from the first communication device 410 to the second communication device 450, the controller/processor 459 performs header compression, encryption, packet segmentation and reordering, and multiplexing between the logic and the transport channel based on radio resource allocation, implementing L2 layer functions for the user plane and the control plane. The controller/processor 459 is also responsible for retransmission of a lost packet and signaling to the first communication device 410. The transmit processor 468 performs modulation mapping, channel encoding processing, and multi-antenna transmit processor 457 to perform digital multi-antenna spatial precoding, including codebook-based precoding and non-codebook-based precoding and beamforming processing, and then the transmit processor 468 modulates the generated spatial stream into a multi-carrier/single-carrier symbol stream, and after the analog precoding/beamforming operation is performed in the multi-antenna transmit processor 457, the transmitter 454 first converts a baseband symbol stream provided by the multi-antenna transmit processor 457 into a radio frequency symbol stream, and then provides the radio frequency symbol stream to the antenna 452.

In the transmission from the second communication device 450 to the first communication device 410, the function at the first communication device 410 is similar to the receiving function at the second communication device 450 described in the transmission from the first communication device 410 to the second communication device 450. Each receiver 418 receives a radio frequency signal through its corresponding antenna 420, converts the received radio frequency signal into a baseband signal, and provides the baseband signal to the multi-antenna receiving processor 472 and the receiving processor 470 to receive the processor 470 and the multi-antenna receiving processor 472 to jointly implement the function of the L1 layer. The controller/processor 475 provides an L2 layer function. The controller/processor 475 can be associated with a memory 476 that stores program code and data. The memory 476 can be referred to as a computer-readable medium. In transmission from the second communication device 450 to the first communication device 410, the controller/processor 475 provides demultiplexing between transport and logical channels, packet reassembly, deciphering, header decompression, control signal processing to recover upper layer data packets from the UE 450. The upper layer data packet from the controller/processor 475 May be provided to the core network.

In one embodiment, the first node in the present disclosure includes the second communication device 450, and the second node in the present disclosure includes the first communication device 410.

In one subembodiment of the above embodiment, the first node is a user equipment, and the second node is a user equipment.

In one subembodiment of the above embodiment, the first node is a user equipment, and the second node is a relay node.

In one subembodiment of the above embodiment, the first node is a relay node, and the second node is a user equipment.

In one subembodiment of the above embodiment, the first node is a relay node, and the second node is a relay node.

In one subembodiment of the above embodiment, the first node is a user equipment, the second node is a user equipment, and the third node is a base station.

In one subembodiment of the above embodiment, the first node is a relay node, the second node is a user equipment, and the third node is a base station.

In one subembodiment of the above embodiment, the second communication device 450 comprises: at least one controller/processor; and the at least one controller/processor is responsible for HARQ operation.

In one subembodiment of the above embodiment, the first communication device 410 comprises: at least one controller/processor; and the at least one controller/processor is responsible for HARQ operation.

In one subembodiment of the above embodiment, the first communication device 410 comprises: at least one controller/processor; the at least one controller/processor is responsible for performing error detection by using a positive acknowledgement (ACK) and/or a negative acknowledgement (NACK) protocol to support HARQ operations.

In one embodiment, the second communication device 450 comprises: at least one processor and at least one memory, wherein the at least one memory comprises computer program code, and the at least one memory and the computer program code are configured to be used with the at least one processor. The second communication device 450 is at least configured to send a target positioning reference signal on a first time-frequency resource block; the first bandwidth component is configured with at least one first-type length and a second length; the first bandwidth component includes frequency domain resources occupied by a plurality of resource pools, and any one of the plurality of resource pools includes at least one slot in a time domain; the first slot set includes a plurality of slots, a quantity of first-type symbols included in any slot in the first slot set and the at least one first-type length are used to determine at least one first-type slot subset from the first slot set, and a quantity of first-type symbols included in any slot in the first slot set and the second length are used to determine a second slot subset from the first slot set, where the first-type symbols include at least uplink symbols; any first-type slot subset in the at least one first-type slot subset is used to determine a time-domain resource occupied by at least one resource pool in the plurality of resource pools, and the second slot subset is used to determine a time-domain resource occupied by at least one resource pool in the plurality of resource pools; the first time-frequency resource block belongs to a first resource pool, the first resource pool is one of the plurality of resource pools, the first slot subset is one of the at least one first-type slot subset, the first slot subset is used to determine a time-domain resource occupied by the first resource pool, and the first length is a first-type length in the at least one first-type length used to determine the first slot subset; a quantity of symbols occupied by the target positioning reference signal in a time domain is not greater than the first length.

In one embodiment, the second communication device 450 comprises: a memory storing a computer-readable instruction program, wherein the computer-readable instruction program generates an action when executed by at least one processor, and the action comprises: sending a target positioning reference signal on a first time-frequency resource block; the first bandwidth component is configured with at least one first-type length and a second length; the first bandwidth component includes frequency domain resources occupied by a plurality of resource pools, and any one of the plurality of resource pools includes at least one slot in a time domain; the first slot set includes a plurality of slots, a quantity of first-type symbols included in any slot in the first slot set and the at least one first-type length are used to determine at least one first-type slot subset from the first slot set, and a quantity of first-type symbols included in any slot in the first slot set and the second length are used to determine a second slot subset from the first slot set, where the first-type symbols include at least uplink symbols; any first-type slot subset in the at least one first-type slot subset is used to determine a time-domain resource occupied by at least one resource pool in the plurality of resource pools, and the second slot subset is used to determine a time-domain resource occupied by at least one resource pool in the plurality of resource pools; the first time-frequency resource block belongs to a first resource pool, the first resource pool is one of the plurality of resource pools, the first slot subset is one of the at least one first-type slot subset, the first slot subset is used to determine a time-domain resource occupied by the first resource pool, and the first length is a first-type length in the at least one first-type length used to determine the first slot subset; a quantity of symbols occupied by the target positioning reference signal in a time domain is not greater than the first length.

In one embodiment, the first communication device 410 comprises: at least one processor and at least one memory, wherein the at least one memory comprises computer program code, and the at least one memory and the computer program code are configured to be used with the at least one processor. The first communication device 410 at least receives a target positioning reference signal on a first time-frequency resource block; the first bandwidth component is configured with at least one first-type length and a second length; the first bandwidth component includes frequency domain resources occupied by a plurality of resource pools, and any one of the plurality of resource pools includes at least one slot in a time domain; the first slot set includes a plurality of slots, a quantity of first-type symbols included in any slot in the first slot set and the at least one first-type length are used to determine at least one first-type slot subset from the first slot set, and a quantity of first-type symbols included in any slot in the first slot set and the second length are used to determine a second slot subset from the first slot set, where the first-type symbols include at least uplink symbols; any first-type slot subset in the at least one first-type slot subset is used to determine a time-domain resource occupied by at least one resource pool in the plurality of resource pools, and the second slot subset is used to determine a time-domain resource occupied by at least one resource pool in the plurality of resource pools; the first time-frequency resource block belongs to a first resource pool, the first resource pool is one of the plurality of resource pools, the first slot subset is one of the at least one first-type slot subset, the first slot subset is used to determine a time-domain resource occupied by the first resource pool, and the first length is a first-type length in the at least one first-type length used to determine the first slot subset; a quantity of symbols occupied by the target positioning reference signal in a time domain is not greater than the first length.

In one embodiment, the first communication device 410 comprises: a memory storing a computer-readable instruction program, wherein the computer-readable instruction program generates an action when executed by at least one processor, and the action comprises: receiving a target positioning reference signal on a first time-frequency resource block; the first bandwidth component is configured with at least one first-type length and a second length; the first bandwidth component includes frequency domain resources occupied by a plurality of resource pools, and any one of the plurality of resource pools includes at least one slot in a time domain; the first slot set includes a plurality of slots, a quantity of first-type symbols included in any slot in the first slot set and the at least one first-type length are used to determine at least one first-type slot subset from the first slot set, and a quantity of first-type symbols included in any slot in the first slot set and the second length are used to determine a second slot subset from the first slot set, where the first-type symbols include at least uplink symbols; any first-type slot subset in the at least one first-type slot subset is used to determine a time-domain resource occupied by at least one resource pool in the plurality of resource pools, and the second slot subset is used to determine a time-domain resource occupied by at least one resource pool in the plurality of resource pools; the first time-frequency resource block belongs to a first resource pool, the first resource pool is one of the plurality of resource pools, the first slot subset is one of the at least one first-type slot subset, the first slot subset is used to determine a time-domain resource occupied by the first resource pool, and the first length is a first-type length in the at least one first-type length used to determine the first slot subset; a quantity of symbols occupied by the target positioning reference signal in a time domain is not greater than the first length.

In one embodiment, at least one of the antenna 452, the transmitter 454, the multi-antenna transmitting processor 457, the transmitting processor 468, the controller/processor 459, the memory 460, and the data source 467 is used for transmitting a target positioning reference signal on a first time-frequency resource block in the present disclosure.

In one embodiment, at least one of the antenna 452, the transmitter 454, the multi-antenna transmitting processor 457, the transmitting processor 468, the controller/processor 459, the memory 460, and the data source 467 is used for transmitting the first control information on the second time-frequency resource block in the present disclosure.

In one embodiment, at least one of the antenna 420, the receiver 418, the multi-antenna receiving processor 472, the receiving processor 470, the controller/processor 475 or the memory 476 is used for receiving a target positioning reference signal on a first time-frequency resource block in the present disclosure.

In one embodiment, at least one of the antenna 420, the receiver 418, the multi-antenna receiving processor 472, the receiving processor 470, the controller/processor 475 or the memory 476 is used for receiving the first control information on the second time-frequency resource block in the present disclosure.

### Example 5

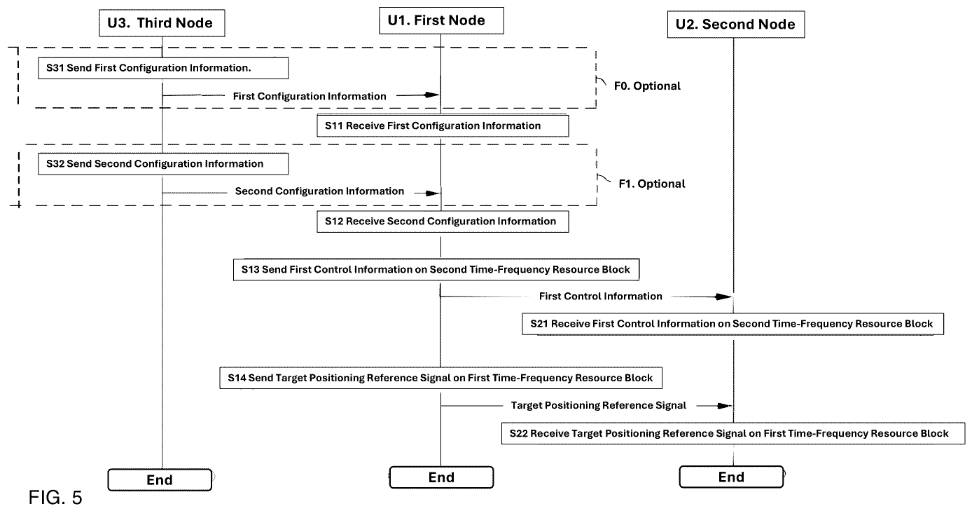

Embodiment 5 illustrates a flowchart of wireless signal transmission according to one embodiment of the present disclosure, as shown in FIG. 5. In FIG. 5, the first node U1, the second node U2 and the third node U3 communicate through an air interface. In FIG. 5, the steps in dashed box FO and dashed box F1 are optional, respectively.

For the first node U1, the first configuration information is received in step S11; the second configuration information is received in step S12; the first control information is sent on the second time-frequency resource block in step S13; and the target positioning reference signal is sent on the first time-frequency resource block in step S14.

For the second node U2, the first control information is received on the second time-frequency resource block in step S21; and the target positioning reference signal is received on the first time-frequency resource block in step S22.

For the third node U3, the first configuration information is sent in step S31; and the second configuration information is sent in step S22.

In Embodiment 5, the first configuration information is used to configure at least one first-type length and a second length of the first bandwidth component; The second configuration information is used to configure a plurality of resource pools, the first bandwidth component includes frequency domain resources occupied by the plurality of resource pools, and any one of the plurality of resource pools includes at least one slot in a time domain; the first slot set includes a plurality of slots, a quantity of first-type symbols included in any slot in the first slot set, the at least one first-type length, and at least one first-type bitmap are jointly used to determine at least one first-type slot subset from the first slot set, a quantity of first-type symbols included in any slot in the first slot set, the second length, and a second bitmap are jointly used to determine a second slot subset from the first slot set, and the first-type symbol includes at least an uplink symbol; any first-type slot subset in the at least one first-type slot subset is used to determine a time-domain resource occupied by at least one resource pool in the plurality of resource pools, and the second slot subset is used to determine a time-domain resource occupied by at least one resource pool in the plurality of resource pools; the first time-frequency resource block belongs to a first resource pool, the first resource pool is one of the plurality of resource pools, the first slot subset is one of the at least one first-type slot subset, the first slot subset is used to determine a time-domain resource occupied by the first resource pool, and the first length is a first-type length in the at least one first-type length used to determine the first slot subset; A quantity of symbols occupied by the target positioning reference signal in a time domain is not greater than the first length; the second slot subset is used to determine a time domain resource occupied by a second resource pool, and the second resource pool is one resource pool of the plurality of resource pools different from the first resource pool; the first time-frequency resource block is determined by the first node U1 from the first resource pool itself, or the first time-frequency resource block is specified by one downlink signaling from the first resource pool; the first control information is used to indicate the first time-frequency resource block; and the second time-frequency resource block belongs to the first resource pool, or the second time-frequency resource block belongs to the second resource pool.

In one embodiment, the first node U1 and the second node U2 communicate through a PC5 interface.

In one embodiment, the first node U1 and the third node U3 communicate through a Uu interface.

In one embodiment, the steps in block FO in FIG. 5 exist, and the steps in block F1 in FIG. 5 exist.

In one embodiment, the step in block FO in FIG. 5 does not exist, and the step in block F1 in FIG. 5 does not exist.

In one embodiment, when the first configuration information and the second configuration information are both pre-configured, the steps in block F0 in FIG. 5 do not exist, and the steps in block F1 in FIG. 5 do not exist.

In one embodiment, when the higher layer of the first node U1 provides the first configuration information and the second configuration information to the physical layer of the first node U1, the step in block F0 in FIG. 5 does not exist, and the step in block F1 in FIG. 5 does not exist.

In one embodiment, when the physical layer of the first node U1 obtains the first configuration information and the second configuration information from a higher layer of the first node, the step in block F0 in FIG. 5 does not exist, and the step in block F1 in FIG. 5 does not exist.

In one embodiment, the first configuration information is preconfigured.

In one embodiment, the second configuration information is preconfigured.

In one embodiment, the first configuration information is provided by a higher layer of the first node U1.

In one embodiment, the second configuration information is provided by a higher layer of the first node U1.

In one embodiment, the first configuration information is obtained by a physical layer of the first node U1 from a higher layer of the first node U1.

In one embodiment, the second configuration information is obtained by a physical layer of the first node U1 from a higher layer of the first node U1.

In one embodiment, the first resource pool is one of the plurality of resource pools, the first resource pool comprises a plurality of time-frequency resource blocks, and the first resource pool comprises the first time-frequency resource block.

In one embodiment, the first resource pool is one of the plurality of resource pools, the first resource pool comprises a plurality of time-frequency resource blocks, and the first time-frequency resource block belongs to the plurality of time-frequency resource blocks comprised in the first resource pool.

In one embodiment, the first resource pool is one of the plurality of resource pools, the first resource pool comprises a plurality of time-frequency resource blocks, and the first time-frequency resource block is one of the plurality of time-frequency resource blocks comprised in the first resource pool.

In one embodiment, the first time-frequency resource block is used to carry the target positioning reference signal.

In one embodiment, the first time-frequency resource block is used to carry an SL PRS.

In one embodiment, the first time-frequency resource block comprises a PSCCH.

In one embodiment, the first time-frequency resource block does not comprise a PSCCH.

In one embodiment, the first time-frequency resource block comprises a PSSCH.

In one embodiment, the first time-frequency resource block does not comprise a PSSCH.

In one embodiment, the first time-frequency resource block is used to carry an SL PRS, and the first time-frequency resource block comprises a PSCCH.

In one embodiment, the first time-frequency resource block is only used to carry an SL PRS, and the first time-frequency resource block does not include a PSCCH and a PSSCH.

In one embodiment, the first node U1 selects the first time-frequency resource block from the plurality of time-frequency resource blocks comprised in the first resource pool.

In one embodiment, the first node U1 automatically determines the first time-frequency resource block from the plurality of time-frequency resource blocks comprised in the first resource pool.

In one embodiment, a downlink signaling indicates the first time-frequency resource block from the plurality of time-frequency resource blocks comprised in the first resource pool.

In one embodiment, the one downlink signaling indicates a position of the first time-frequency resource block in the plurality of time-frequency resource blocks comprised in the first resource pool.

In one embodiment, the first configuration information is used to configure the at least one first-type length of the first bandwidth part.

In one embodiment, the first configuration information is used to configure the at least one first-type length and a second length of the first bandwidth part.

In one embodiment, the first configuration information is used to configure related parameters of the first bandwidth part.

In one embodiment, the first configuration information comprises the at least one first-type length.

In one embodiment, the first configuration information comprises the at least one first-type length and the second length.

In one embodiment, the first configuration information comprises all or part of a Radio Resource Control (RRC) layer signaling.

In one embodiment, the first configuration information comprises one or more fields in an RRC i.e. (Information Element).

In one embodiment, the first configuration information comprises an RRC i.e. an SL-BWP-Config.

In one embodiment, the definition of the SL-BWP-Config refers to section 6.3 of 3 GPP TS 38.331.5.

In one embodiment, the first configuration information comprises one field in an RRC i.e. and SL-BWP-Generic.

In one embodiment, the SL-BWP-Generic definition refers to section 6.3 of 3 GPP TS 38.331.5.

In one embodiment, the second configuration information is used to configure the plurality of resource pools, and frequency domain resources occupied by the plurality of resource pools belong to the first bandwidth part.

In one embodiment, the second configuration information is used to configure related parameters of the first bandwidth part.

In one embodiment, the second configuration information comprises an identifier of any one of the plurality of resource pools.

In one embodiment, the second configuration information comprises time-frequency resources occupied by any one of the plurality of resource pools.

In one embodiment, the second configuration information comprises relevant parameters of any one of the plurality of resource pools.

In one embodiment, the second configuration information comprises all or part of an RRC layer signaling.

In one embodiment, the second configuration information comprises one or more fields in an RRC i.e.

In one embodiment, the second configuration information comprises an RRC i.e. an SL-BWP-and an OolDonOnfig.

In one embodiment, the definition of the SL-BWP-PoolConfig refers to section 6.3 of 3 GPP TS 38.331.5.

In one embodiment, the first configuration information comprises an RRC i.e. an SL-ClieSourceCool OOL.

In one embodiment, the definition of the SL-ResourcePool refers to section 6.3 of 3 GPP TS 38.331.5.

In one embodiment, the first control information is used to indicate the first time-frequency resource block.

In one embodiment, the first control information is used to indicate the first resource pool.

In one embodiment, the first control information is used to indicate the first time-frequency resource block from the first resource pool.

In one embodiment, the first control information is used to indicate the target positioning reference signal.

In one embodiment, the first control information is used to indicate related parameters of the target positioning reference signal.

In one embodiment, the first control information is used to indicate the first sequence, and the first sequence is used to generate the target positioning reference signal.

In one embodiment, the first control information is used to indicate a symbol occupied by the target positioning reference signal.

In one embodiment, the first control information is used to indicate a symbol occupied by the target positioning reference signal in a slot.

In one embodiment, the second time-frequency resource block belongs to the first resource pool.

In one embodiment, the second time-frequency resource block is one of a plurality of time-frequency resource blocks comprised in the first resource pool.

In one embodiment, the second time-frequency resource block belongs to the second resource pool.

In one embodiment, the second time-frequency resource block is one of a plurality of time-frequency resource blocks comprised in the second resource pool.

In one embodiment, the first time-frequency resource block belongs to the first resource pool, and the second time-frequency resource block belongs to the second resource pool.

In one embodiment, the first time-frequency resource block and the second time-frequency resource block both belong to the first resource pool.

In one embodiment, the first time-frequency resource block and the second time-frequency resource block are respectively two time-frequency resource blocks in the first resource pool.

In one embodiment, the first time-frequency resource block is a time-frequency resource block in the first resource pool, and the second time-frequency resource block is a time-frequency resource block in the second resource pool.

### Example 6

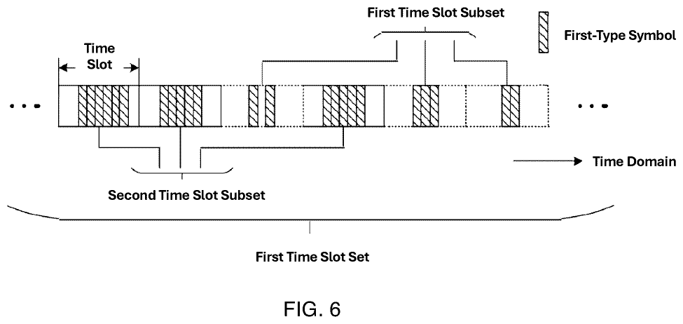

Embodiment 6 illustrates a schematic diagram of a relationship between a first slot set and a first-type slot subset and a second slot subset according to one embodiment of the present disclosure, as shown in FIG. 6.

In Embodiment 6, the first slot set includes a plurality of slots, and a quantity of first-type symbols included in any time slot in the first slot set and the at least one first-type length configured for the first bandwidth component are used to determine at least one first-type slot subset from the first slot set; a quantity of first-type symbols included in any time slot in the first slot set and the second length configured for the first bandwidth component are used to determine a second slot subset from the first slot set, where the first-type symbol is an uplink symbol.

In one embodiment, the first slot set comprises a plurality of slots.

In one embodiment, a number of the plurality of time slots comprised in the first time slot set is a multiple of 10240.

In one embodiment, a number of the plurality of time slots comprised in the first time slot set is related to a subcarrier spacing of subcarriers in the first bandwidth part.

In one embodiment, a number of the plurality of time slots comprised in the first time slot set is equal to a product of 10240 and 2 mu, and mu is an integer from 0 to 6.

In one subembodiment of the above embodiment, the MU is related to a subcarrier spacing of subcarriers in the first bandwidth part.

In one subembodiment of the above embodiment, the subcarrier spacing of a subcarrier in the first bandwidth part is used to determine the MU.

In one subembodiment of the above embodiment, the subcarrier spacing of a subcarrier in the first bandwidth part is 15 kHz, and mu is 0.

In one subembodiment of the above embodiment, the subcarrier spacing of a subcarrier in the first bandwidth part is 60 kHz, and mu is 2.

In one embodiment, the first slot set comprises any first-type slot subset in the at least one first-type slot subset.

In one embodiment, any first-type slot subset in the at least one first-type slot subset belongs to the first slot set.

In one embodiment, any of the at least one first-type slot subset comprises a plurality of slots.

In one embodiment, the plurality of slots comprised in any of the at least one first-type slot subset belong to the first slot set.

In one embodiment, any one of the at least one first-type slot subset in the at least one first-type slot subset is one slot in the first slot set.

In one embodiment, a quantity of first-type symbols included in any time slot in the first time slot set and the at least one first-type length configured for the first bandwidth component are used to determine the at least one first-type time slot subset from the first time slot set.

In one embodiment, a size relationship between the number of first-type symbols included in any time slot in the first time slot set and the at least one first-type length configured by the first bandwidth component is used to determine the at least one first-type time slot subset from the first time slot set.

In one embodiment, a number of first-type symbols comprised in any time slot in the first slot set is used together with the at least one first-type length configured by the first bandwidth component to determine the at least one first-type slot subset from the first slot set.

In one embodiment, a first candidate length is any one of the at least one first-type length, and the number of first-type symbols comprised in any time slot in the first time-slot set and the first candidate length are used to determine a first candidate slot subset from the first slot set, the first candidate slot subset being one of the at least one first-type slot subset.

In one embodiment, a first candidate slot subset is any first-type slot subset in the at least one first-type slot subset, and the number of first-type symbols included in any slot in the first slot set and a first candidate length are used to determine the first candidate slot subset from the first slot set, the first candidate length being one of the at least one first-type slot subset.

In one embodiment, a size relationship between the number of first-type symbols included in any time slot in the first time slot set and any one of the at least one first-type length configured by the first bandwidth component is used to determine one first-type time slot subset in the at least one first-type time slot subset from the first time slot set.

In one embodiment, a size relationship between the number of first-type symbols included in any time slot in the first time slot set and the at least one first-type length configured by the first bandwidth component is respectively used for determining the at least one first-type time slot subset from the first time slot set.

In one embodiment, a first candidate length is any one of the at least one first-type length, a size relationship between the number of first-type symbols included in any time slot in the first slot set and the first candidate length is used to determine a first candidate slot subset from the first slot set, and the first candidate slot subset is one of the at least one first-type slot subset.

In one embodiment, a first candidate slot subset is any first-type slot subset in the at least one first-type slot subset, a size relationship between the number of first-type symbols included in any slot in the first slot set and a first candidate length is used to determine the first candidate slot subset from the first slot set, and the first candidate length is one of the at least one first-type slot subset.

In one embodiment, a first candidate slot is one slot in the first slot set, a first candidate length is one of the at least one first-type length, and a relationship between the number of the first-type symbols included in the first candidate slot and the first candidate length is used to determine whether the first candidate slot belongs to the first candidate slot subset.

In one embodiment, a first candidate slot is one slot in the first slot set, a first candidate length is one of the at least one first-type length, and whether the first candidate slot belongs to the first candidate slot subset is related to a size relationship between the first candidate slot subset and the first candidate length.

In one embodiment, the first candidate slot is any slot in the first slot set.

In one embodiment, the first candidate slot is any slot in the first slot set that does not carry an SL-SSB.

In one embodiment, whether the number of the first-type symbols comprised in the first candidate slot is not less than the first candidate length is used to determine whether the first candidate slot belongs to the first candidate slot subset.

In one embodiment, whether the number of the first-type symbols comprised in the first candidate slot is equal to the first candidate length is used to determine whether the first candidate slot belongs to the first candidate slot subset.

In one embodiment, whether the first candidate slot belongs to whether the number of the first candidate slot subset and the first-type symbol comprised in the first candidate slot is not less than the first candidate length.

In one embodiment, whether the first candidate slot belongs to the first candidate slot subset is related to whether the number of the first-type symbols comprised in the first candidate slot is equal to the first candidate length.

In one embodiment, the number of the first-type symbols comprised in the first candidate slot is less than the first candidate length, and the first candidate slot does not belong to the first candidate slot subset.

In one embodiment, the number of the first-type symbols comprised in the first candidate slot is greater than the first candidate length, and the first candidate slot belongs to the first candidate slot subset.

In one embodiment, the number of the first-type symbols comprised in the first candidate slot is equal to the first candidate length, and the first candidate slot belongs to the first candidate slot subset.

In one embodiment, the number of the first-type symbols comprised in the first candidate slot is not equal to the first candidate length, and the first candidate slot does not belong to the first candidate slot subset.

In one embodiment, when the number of the first-type symbols comprised in the first candidate slot is less than the first candidate length, the first candidate slot does not belong to the first candidate slot subset; when the number of the first-type symbols included in the first candidate slot is equal to the first candidate length, the first candidate slot belongs to the first candidate slot subset; and when the number of the first-type symbols included in the first candidate slot is greater than the first candidate length, the first candidate slot belongs to the first candidate slot subset.

In one embodiment, when the number of the first-type symbols comprised in the first candidate slot is equal to the first candidate length, the first candidate slot belongs to the first candidate slot subset; and when the number of the first-type symbols comprised in the first candidate slot is not equal to the first candidate length, the first candidate slot does not belong to the first candidate slot subset.

In one embodiment, any one of the Y1, Y1+1, . . . (Y1+X1−1) symbols is the first-type symbol used to determine whether the first candidate slot belongs to the first candidate slot subset, X1 is equal to the first candidate length, and Y1 is an integer from 0 to 7.

In one embodiment, at least one of the Y1, Y1+1, . . . (Y1+X1−1) symbols is not the first-type symbol, the first candidate slot does not belong to the first candidate slot subset, X1 is equal to the first candidate length, and Y1 is an integer from 0 to 7.

In one embodiment, any of the Y1, Y1+1, . . . (Y1+X1−1) symbols is the first-type symbol, the first candidate slot belongs to the first candidate slot subset, X1 is equal to the first candidate length, and Y1 is an integer from 0 to 7.

In one embodiment, at least one of the Y1, Y1+1, . . . (Y1+X1−1) symbols is not semi-statically configured to be uplink, the first candidate slot does not belong to the first candidate slot subset, X1 is equal to the first candidate length, and Y1 is an integer from 0 to 7.

In one embodiment, any of the Y1, Y1 +1, . . . (Y1+X1−1) symbols is semi-statically configured as uplink, the first candidate slot belongs to the first candidate slot subset, X1 is equal to the first candidate length, and Y1 is an integer from 0 to 7.

In one embodiment, the first slot set comprises the first slot subset.

In one embodiment, the first slot subset belongs to the first slot set.

In one embodiment, the first slot subset is one of the at least one first-type slot subset.

In one embodiment, the first slot subset comprises a plurality of slots.

In one embodiment, the plurality of time slots comprised in the first time slot subset belong to the first time slot set.

In one embodiment, any time slot in the first slot subset is one slot in the first slot set.

In one embodiment, the first length is used to determine a first slot subset from the first slot set, the first slot subset being one of the at least one first-type slot subset.

In one embodiment, the first slot subset comprises a plurality of slots, and the number of the first-type symbols comprised in any slot in the first slot subset is not less than the first length.

In one embodiment, the first slot subset comprises a plurality of slots, and a number of the first-type symbols comprised in any slot in the first slot subset is greater than the first length.

In one embodiment, the first slot subset comprises a plurality of slots, and a number of the first-type symbols comprised in any slot in the first slot subset is equal to the first length.

In one embodiment, any of the Y1, Y1+1, . . . (Y1+X1−1) symbols is the first-type symbol, X1 is equal to the first length, and Y1 is an integer from 0 to 7.

In one embodiment, any of the Y1, Y1+1, . . . (Y1+X1−1) symbols is semi-statically configured to uplink, X1 is equal to the first length, and Y1 is an integer from 0 to 7.

In one embodiment, the first slot set comprises the second slot subset.

In one embodiment, the second slot subset belongs to the first slot set.

In one embodiment, the second slot subset comprises a plurality of slots.

In one embodiment, the plurality of time slots comprised in the second time slot subset belong to the first time slot set.

In one embodiment, any time slot in the second slot subset is one slot in the first slot set.

In one embodiment, a number of first-type symbols comprised in any time slot in the first slot set and the second length are used to determine the second slot subset from the first slot set.

In one embodiment, a relationship between the number of first-type symbols included in any time slot in the first slot set and the second length is used to determine the second slot subset from the first slot set.

In one embodiment, a second candidate slot is one slot in the first slot set, and a relationship between the number of the first-type symbols included in the second candidate slot and the second length is used to determine whether the second candidate slot belongs to the second slot subset.

In one embodiment, a second candidate slot is one slot in the first slot set, and whether the second candidate slot belongs to the second slot subset is related to a size relationship between the number of the first-type symbols included in the second candidate slot and the second length.

In one embodiment, the second candidate slot is any slot in the first slot set.

In one embodiment, the second candidate slot is any slot in the first slot set that does not carry an SL-SSB.

In one embodiment, whether the number of the first-type symbols comprised in the second candidate slot is not less than the second length is used to determine whether the second candidate slot belongs to the second slot subset.

In one embodiment, whether the second candidate slot belongs to whether the number of the first-type symbols comprised in the second slot subset and the second candidate slot is not less than the second length.

In one embodiment, ay of the Y, (Y+1), . . . (Y+X−1) symbols is the first type symbol and is used to determine whether the second alternative slot belongs to the second subset of slots, X is equal to the second length, and Y is an integer from 0 to 7.

In one embodiment, at least one of the Y, (Y+1), . . . (Y+X−1) symbols is not the first-type symbol, the second candidate slot does not belong to the second slot subset, X is equal to the second length, and Y is an integer from 0 to 7.

In one embodiment, any of the Y, (Y+1), . . . (Y+X−1) symbols is the first-type symbol, the second candidate slot belongs to the second slot subset, X is equal to the second length, and Y is an integer from 0 to 7.

In one embodiment, at least one of the Y, (Y+1), . . . (Y+X−1) symbols is not semi-statically configured to uplink, the second candidate slot does not belong to the second slot subset, X is equal to the second length, and Y is an integer from 0 to 7.

In one embodiment, any of the Y, (Y+1), . . . (Y+X−1) symbols is semi-statically configured to uplink, the second alternative slot belongs to the second subset of slots, X is equal to the second length, and Y is an integer from 0 to 7.

### Example 7

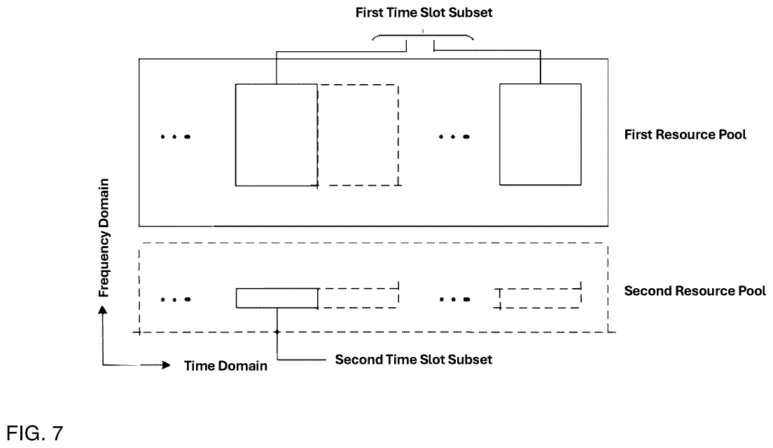

Embodiment 7 illustrates a schematic diagram of a relationship between a first slot subset, a second slot subset and a first resource pool according to one embodiment of the present disclosure, as shown in FIG. 7. In FIG. 7, a solid line large block represents a first resource pool in the present disclosure; the dashed large box represents the second resource pool in the present disclosure; the dotted rectangle in the large box represents the time-frequency resource block not belonging to the first resource pool in the present disclosure; the solid rectangle in the dotted large box represents the time-frequency resource block belonging to the second resource pool in the present disclosure; and the dotted rectangle in the dotted large box represents the time-frequency resource block not belonging to the second resource pool in the present disclosure.

In Embodiment 7, the first slot subset is used to determine time domain resources occupied by a first resource pool, the second slot subset is used to determine time domain resources occupied by a second resource pool, and the second resource pool and the first resource pool are two different resource pools in the plurality of resource pools in this application.

In one embodiment, the first candidate slot subset is any first-type slot subset in the at least one first-type slot subset, and the first candidate slot subset comprises a plurality of slots.

In one embodiment, the first candidate slot subset is used to determine time-domain resources occupied by at least one resource pool of the plurality of resource pools.

In one embodiment, the first candidate slot subset is used to determine that a time-domain resource occupied by at least one resource pool of the plurality of resource pools belongs to the plurality of slots included in the first candidate slot subset.

In one embodiment, the first candidate slot subset is used to determine that a time-domain resource occupied by at least one resource pool of the plurality of resource pools is the plurality of slots included in the first candidate slot subset.

In one embodiment, the first candidate slot subset is used to determine that a time-domain resource occupied by at least one resource pool of the plurality of resource pools comprises a plurality of slots, and any one of the time-domain resources occupied by the at least one resource pool is one slot in the first candidate slot subset.

In one embodiment, the first resource pool is one of the plurality of resource pools.

In one embodiment, the first resource pool is used for sidelink positioning.

In one embodiment, the first resource pool is used for sidelink communication.

In one embodiment, the first resource pool is used for sidelink communication and sidelink positioning.

In one embodiment, the first resource pool is only used for sidelink positioning.

In one embodiment, the first resource pool is used to carry an SL PRS.

In one embodiment, the first resource pool is used to carry an SL-SCH.

In one embodiment, the first resource pool is used to carry SCI.

In one embodiment, the first resource pool is used to carry an SL MAC CE (Control Element of Multimedia Access Control Control Element).

In one embodiment, the first resource pool is used to carry a PSCCH DMRS.

In one embodiment, the first resource pool is used to carry a PSSCH DMRS.

In one embodiment, the first resource pool comprises a PSCCH.

In one embodiment, the first resource pool comprises a PSCCH and a PSSCH.

In one embodiment, the first resource pool comprises a PSCCH, a PSSCH, and a PSFCH.

In one embodiment, the first resource pool is used to carry an SL PRS, and the first resource pool comprises at least the former of a PSCCH and a PSSCH.

In one embodiment, the first resource pool is used to carry an SL PRS, and the first resource pool does not comprise a PSSCH.

In one embodiment, the first resource pool is used for carrying an SL PRS, the first resource pool comprises a PSCCH, and the first resource pool does not comprise a PSSCH.

In one embodiment, the first resource pool is used to carry an SL PRS, and the first resource pool does not include a PSCCH and a PSSCH.

In one embodiment, the first resource pool is only used to carry an SL PRS.

In one embodiment, the first slot subset is used to determine time-domain resources occupied by the first resource pool.

In one embodiment, the first resource pool comprises a plurality of time slots belonging to the first time slot subset in a time domain.

In one embodiment, a time domain resource occupied by the first resource pool comprises a plurality of time slots, and any time slot in time domain resources occupied by the first resource pool is one time slot in the first time slot subset.

In one embodiment, the plurality of time slots comprised in a time domain of the first resource pool correspond to the plurality of time slots included in the first time slot subset on a one-to-one basis.

In one embodiment, the plurality of time slots comprised in a time domain of the first resource pool are respectively the plurality of time slots included in the first time slot subset.

In one embodiment, the second resource pool is one of the plurality of resource pools.

In one embodiment, the second resource pool is used for sidelink communication.

In one embodiment, the second resource pool is used for sidelink communication and sidelink positioning.

In one embodiment, the second resource pool is used to carry an SL-SCH.

In one embodiment, the second resource pool is used to carry SCI.

In one embodiment, the second resource pool is used to carry an SL MAC CE.

In one embodiment, the second resource pool is used to carry an SL PRS.

In one embodiment, the second resource pool is used to carry a PSCCH DMRS.

In one embodiment, the second resource pool is used to carry a PSSCH DMRS.

In one embodiment, the second resource pool comprises a PSCCH.

In one embodiment, the second resource pool comprises a PSCCH and a PSSCH.

In one embodiment, the second resource pool comprises a PSCCH, a PSSCH, and a PSFCH.

In one embodiment, the second resource pool comprises at least the former of a PSCCH and a PSSCH, and the second resource pool is used for carrying an SL PRS.

In one embodiment, the second resource pool comprises at least the former of a PSCCH and a PSSCH, and the second resource pool is not used to carry an SL PRS.

In one embodiment, the second slot subset is used to determine time-domain resources occupied by at least one resource pool of the plurality of resource pools.

In one embodiment, the second resource pool is one of the at least one resource pool determined by the second slot subset in the plurality of resource pools.

In one embodiment, the second slot subset is used to determine that a time-domain resource occupied by at least one resource pool of the plurality of resource pools belongs to the plurality of slots included in the second slot subset.

In one embodiment, the second slot subset is used to determine that a time-domain resource occupied by at least one resource pool of the plurality of resource pools is the plurality of slots included in the second slot subset.

In one embodiment, the second slot subset is used to determine that a time-domain resource occupied by at least one resource pool of the plurality of resource pools comprises a plurality of slots, and any one of the time-domain resources occupied by the at least one resource pool is one slot in the second slot subset.

In one embodiment, the second slot subset is used to determine time-domain resources occupied by the second resource pool.

In one embodiment, the second resource pool comprises a plurality of time slots belonging to the second time slot subset in time domain.

In one embodiment, a time domain resource occupied by the second resource pool comprises a plurality of time slots, and any time slot in time domain resources occupied by the second resource pool is one time slot in the second time slot subset.

In one embodiment, the plurality of time slots comprised in a time domain of the second resource pool correspond to the plurality of time slots included in the second time slot subset on a one-to-one basis.

In one embodiment, the plurality of time slots comprised in a time domain of the second resource pool are respectively the plurality of time slots comprised in the second time slot subset.

In one embodiment, the first resource pool is used for sidelink positioning, and the second resource pool is used for sidelink communication.

In one embodiment, the first resource pool is used to carry an SL PRS, and the second resource pool comprises at least the former of a PSCCH and a PSSCH.

In one embodiment, the first resource pool is used for carrying an SL PRS, the first resource pool comprises a PSCCH, and the second resource pool comprises at least the former of a PSCCH and a PSSCH.

In one embodiment, the second resource pool is orthogonal to the first resource pool.

In one embodiment, the second resource pool and the first resource pool are orthogonal in frequency domain.

In one embodiment, the second resource pool and the first resource pool are orthogonal in time domain.

In one embodiment, the second resource pool overlaps with the first resource pool.

In one embodiment, the second resource pool and the first resource pool overlap in time domain.

In one embodiment, the second resource pool and the first resource pool overlap in frequency domain.

In one embodiment, the second resource pool and the first resource pool are orthogonal in frequency domain, and the second resource pool and the first resource pool overlap in time domain.

In one embodiment, the second resource pool and the first resource pool are orthogonal in time domain, and the second resource pool and the first resource pool overlap in frequency domain.

In one embodiment, the second resource pool and the first resource pool are FDM.

In one embodiment, the second resource pool and the first resource pool are TDM.

In one embodiment, the second resource pool and the first resource pool belong to a same carrier frequency.

In one embodiment, frequency-domain resources occupied by the second resource pool and frequency-domain resources occupied by the first resource pool belong to a same carrier frequency.

In one embodiment, the second resource pool and the first resource pool belong to a same bandwidth part.

In one embodiment, frequency-domain resources occupied by the second resource pool and frequency-domain resources occupied by the first resource pool belong to a same bandwidth part.

In one embodiment, frequency-domain resources occupied by the second resource pool and frequency-domain resources occupied by the first resource pool belong to a same SL BWP.

In one embodiment, the number of sub-channels comprised in the second resource pool is not equal to the number of sub-channels comprised in the first resource pool.

In one embodiment, a number of sub-channels comprised in the second resource pool is equal to a number of sub-channels comprised in the first resource pool.

In one embodiment, a number of sub-channels comprised in the second resource pool is greater than a number of sub-channels comprised in the first resource pool.

In one embodiment, a number of sub-channels comprised in the second resource pool is less than a number of sub-channels comprised in the first resource pool.

In one embodiment, a frequency-domain resource occupied by any sub-channel in the second resource pool is equal to a frequency-domain resource occupied by any sub-channel in the first resource pool.

In one embodiment, a frequency-domain resource occupied by any sub-channel in the second resource pool is not equal to a frequency-domain resource occupied by any sub-channel in the first resource pool.

In one embodiment, a frequency-domain resource occupied by any sub-channel in the second resource pool is greater than a frequency-domain resource occupied by any sub-channel in the first resource pool.

In one embodiment, a frequency-domain resource occupied by any sub-channel in the second resource pool is less than a frequency-domain resource occupied by any sub-channel in the first resource pool.

In one embodiment, a number of physical resource blocks comprised in any sub-channel in the second resource pool is equal to a number of physical resource blocks comprised in any sub-channel in the first resource pool.

In one embodiment, a number of physical resource blocks comprised in any sub-channel in the second resource pool is not equal to a number of physical resource blocks comprised in any sub-channel in the first resource pool.

In one embodiment, a number of physical resource blocks comprised in any sub-channel in the second resource pool is greater than a number of physical resource blocks comprised in any sub-channel in the first resource pool.

In one embodiment, a number of physical resource blocks comprised in any sub-channel in the second resource pool is less than a number of physical resource blocks comprised in any sub-channel in the first resource pool.

### Example 8

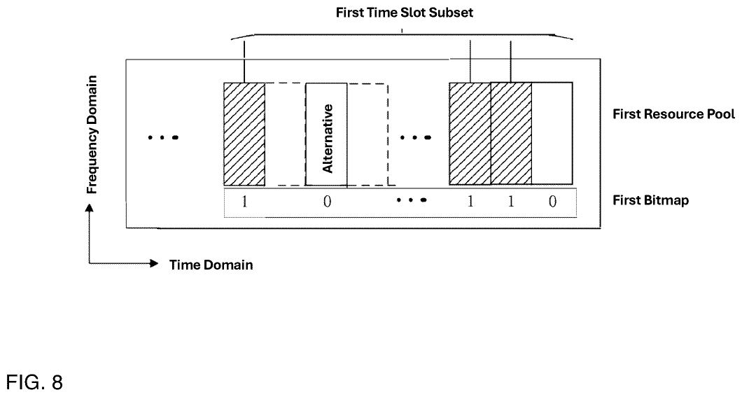

Embodiment 8 illustrates a schematic diagram of a relationship between a first candidate slot, a first bitmap, and a first slot subset according to one embodiment of the present disclosure, as shown in FIG. 8. The solid line large box represents the first resource pool of the present application, the solid line rectangle represents the first alternative time slot in the present application, and the twill filled rectangle represents one time slot in the first time slot subset in the present application.

In Embodiment 8, the first bitmap is one of the at least one first-type bitmap, the first candidate slot is any slot in the first slot set, and a quantity of first-type symbols included in the first candidate slot is jointly used to determine whether the first candidate slot belongs to the first slot subset.

In one embodiment, the at least one first-type length and at least one first-type bitmap are jointly used to determine the at least one first-type time slot subset.

In one embodiment, the first candidate length is one of the at least one first-type length, the first candidate bitmap is one of the first-type bitmap, and the first candidate length and the first candidate bitmap are jointly used to determine a first-type slot subset in the at least one first-type slot subset.

In one embodiment, the first candidate length is one of the at least one first-type length, the first bitmap is one of the first-type bitmaps, the first candidate slot subset is one of the at least one first-type slot subset, and the first candidate length and the first candidate bitmap are jointly used to determine the first candidate slot subset.

In one embodiment, the first candidate slot is one slot in the first slot set, and a size relationship between the number of the first-type symbols included in the first candidate slot and the first candidate length and the first candidate bitmap are jointly used to determine the first candidate slot subset.

In one embodiment, the first candidate slot is one slot in the first slot set, and whether the number of the first-type symbols comprised in the first candidate slot is not less than the first candidate length and the first candidate bitmap is jointly used to determine the first candidate slot subset.

In one embodiment, the first candidate slot is one slot in the first slot set, the number of the first-type symbols included in the first candidate slot is not less than the first candidate length, the first candidate bitmap comprises a plurality of bits, the first candidate slot corresponds to one bit in the first candidate bitmap, and the one bit in the first candidate bitmap is used to indicate whether the first candidate slot belongs to the first candidate slot subset.

In one embodiment, the first candidate slot is one slot in the first slot set, the number of the first-type symbols included in the first candidate slot is not less than the first candidate length, the first candidate bitmap comprises a plurality of bits, and the first candidate slot corresponds to one bit in the first candidate bitmap; a value of the one bit in the first candidate bitmap is 1, the first candidate slot belongs to the first candidate slot subset, or a value of the one bit in the first candidate bitmap is 0, and the first candidate slot does not belong to the first candidate slot subset.

In one embodiment, the first length and the first bitmap are jointly used to determine the first slot subset.

In one embodiment, the first candidate slot is one slot in the first slot set, and whether the number of the first-type symbols comprised in the first candidate slot is not less than the first length and the first bitmap is jointly used to determine the first slot subset.

In one embodiment, the first candidate slot is one slot in the first slot set, and the number of the first-type symbols included in the first candidate slot is jointly used to determine the first slot subset with a size relationship between the first length and the first bitmap.

In one embodiment, the first bitmap is one of the at least one first-type bitmap, and the first bitmap comprises a plurality of bits.

In one embodiment, the first slot set comprises a first slot group, the first slot group comprises a plurality of slots, and the number of first-type symbols comprised in any slot in the first slot is not less than the first length.

In one embodiment, the first slot set comprises a first slot group, the first slot group comprises a plurality of slots, and the number of first-type symbols comprised in any slot in the first slot is equal to the first length.

In one embodiment, the plurality of bits comprised in the first bitmap are respectively in one-to-one correspondence with the plurality of slots comprised in the first slot group.

In one embodiment, the plurality of bits comprised in the first bitmap respectively indicate whether the plurality of slots comprised in the first slot group belong to the first slot subset.

In one embodiment, the first candidate slot is one slot in the first slot set, the number of the first-type symbols included in the first candidate slot is not less than the first length, the first bitmap comprises a plurality of bits, the first candidate slot corresponds to one bit in the first bitmap, and the one bit in the first bitmap is used to indicate whether the first candidate slot belongs to the first slot subset.

In one embodiment, the first candidate slot is one slot in the first slot set, the number of the first-type symbols included in the first candidate slot is equal to the first length, the first bitmap comprises a plurality of bits, the first candidate slot corresponds to one bit in the first bitmap, and the one bit in the first bitmap is used to indicate whether the first candidate slot belongs to the first slot subset.

In one embodiment, the first candidate slot is one slot in the first slot set, the number of the first-type symbols included in the first candidate slot is not less than the first length, the first bitmap comprises a plurality of bits, and the first candidate slot corresponds to one bit in the first bitmap; a value of the one bit in the first bitmap is 1, the first candidate slot belongs to the first slot subset, or a value of the one bit in the first bitmap is 0, and the first candidate slot does not belong to the first slot subset.

In one embodiment, the first candidate slot is one slot in the first slot set, the number of the first-type symbols included in the first candidate slot is equal to the first length, the first bitmap comprises a plurality of bits, and the first candidate slot corresponds to one bit in the first bitmap; a value of the one bit in the first bitmap is 1, the first candidate slot belongs to the first slot subset, or a value of the one bit in the first bitmap is 0, and the first candidate slot does not belong to the first slot subset.

In one embodiment, the first candidate slot is one slot in the first slot group, the first bitmap comprises a plurality of bits, and the first candidate slot corresponds to one bit in the first bitmap; a value of the one bit in the first bitmap is 1, the first candidate slot belongs to the first slot subset, or a value of the one bit in the first bitmap is 0, and the first candidate slot does not belong to the first slot subset.

### Example 9

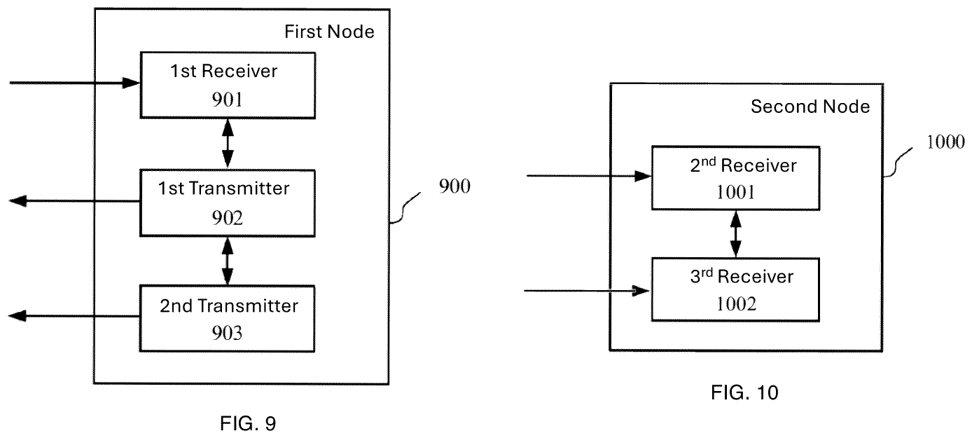

Embodiment 9 illustrates a structural block diagram of a processing apparatus in a first node, as shown in FIG. 9. In Embodiment 9, the first node device processing apparatus 900 is mainly composed of a first receiver 901, a first transmitter 902, and a second transmitter 903.

In one embodiment, the first receiver 901 comprises at least one of the antenna 452, the transmitter/receiver 454, the multi-antenna receiving processor 458, the receiving processor 456, the controller/processor 459 and the memory 460 in FIG. 4 of the present disclosure.

In one embodiment, the first transmitter 902 comprises at least one of the antenna 452, the transmitter/receiver 454, the multi-antenna transmitter processor 457, the transmitting processor 468, the controller/processor 459, the memory 460, and the data source 467 in FIG. 4 of the present disclosure.

In one embodiment, the second transmitter 903 comprises at least one of the antenna 452, the transmitter/receiver 454, the multi-antenna transmitter processor 457, the transmitting processor 468, the controller/processor 459, the memory 460, and the data source 467 in FIG. 4 of the present disclosure.

In Embodiment 9, the first transmitter 902 sends a target positioning reference signal on a first time-frequency resource block; The first bandwidth component is configured with at least one first-type length and a second length; The first bandwidth component includes frequency domain resources occupied by a plurality of resource pools, and any one of the plurality of resource pools includes at least one slot in a time domain; The first slot set includes a plurality of slots, a quantity of first-type symbols included in any slot in the first slot set and the at least one first-type length are used to determine at least one first-type slot subset from the first slot set, and a quantity of first-type symbols included in any slot in the first slot set and the second length are used to determine a second slot subset from the first slot set, where the first-type symbols include at least uplink symbols; Any first-type slot subset in the at least one first-type slot subset is used to determine a time-domain resource occupied by at least one resource pool in the plurality of resource pools, and the second slot subset is used to determine a time-domain resource occupied by at least one resource pool in the plurality of resource pools; The first time-frequency resource block belongs to a first resource pool, the first resource pool is one of the plurality of resource pools, the first slot subset is one of the at least one first-type slot subset, the first slot subset is used to determine a time-domain resource occupied by the first resource pool, and the first length is a first-type length in the at least one first-type length used to determine the first slot subset; a quantity of symbols occupied by the target positioning reference signal in a time domain is not greater than the first length.

In one embodiment, the second slot subset is used for determining a time-domain resource occupied by a second resource pool, and the second resource pool is a resource pool of the plurality of resource pools different from the first resource pool.

In one embodiment, the target positioning reference signal is used for sidelink positioning.

In one embodiment, a number of symbols occupied by the target positioning reference signal in a time domain is equal to the first length.

In one embodiment, the first length is not equal to the second length.

In one embodiment, the at least one first-type length and at least one first-type bitmap are jointly used to determine the at least one first-type time slot subset.

In one embodiment, a first bitmap is one of the at least one first-type bitmap, a first candidate slot is any slot in the first slot set, and a quantity of first-type symbols included in the first candidate slot is jointly used to determine whether the first candidate slot belongs to the first slot subset.

In one embodiment, the first time-frequency resource block is determined by the first node from the first resource pool.

In one embodiment, the first time-frequency resource block is specified by one downlink signaling from the first resource pool.

In one embodiment, the first receiver 901 receives first configuration information, wherein the first configuration information is used to configure the at least one first-type length of the first bandwidth part.

In one embodiment, the first receiver 901 receives second configuration information, wherein the second configuration information is used to configure the plurality of resource pools.

In one embodiment, the second transmitter 903 transmits first control information on a second time-frequency resource block, the first control information being used to indicate the first time-frequency resource block, the second time-frequency resource block belonging to the first resource pool, or the second time-frequency resource block belonging to the second resource pool.

In one embodiment, the first node 900 is a user equipment.

In one embodiment, the first node 900 is a relay node.

In one embodiment, the first node 900 is a base station device.

### Example 10

Embodiment 10 illustrates a structural block diagram of a processing device in a second node, as shown in FIG. 10. In Embodiment 10, the second node device processing apparatus 1000 is mainly composed of a second receiver 1001 and a third receiver 1002.

In one embodiment, the second receiver 1001 comprises at least one of the antenna 420, the transmitter/receiver 418, the multi-antenna receiving processor 472, the receiving processor 470, the controller/processor 475 or the memory 476 in FIG. 4 of the present disclosure.

In one embodiment, the third receiver 1002 comprises at least one of the antenna 420, the transmitter/receiver 418, the multi-antenna receiving processor 472, the receiving processor 470, the controller/processor 475 or the memory 476 in FIG. 4 of the present disclosure.

In Embodiment 11, the second receiver 1101 receives a target positioning reference signal on a first time-frequency resource block; The first bandwidth component is configured with at least one first-type length and a second length; The first bandwidth component includes frequency domain resources occupied by a plurality of resource pools, and any one of the plurality of resource pools includes at least one slot in a time domain; The first slot set includes a plurality of slots, a quantity of first-type symbols included in any slot in the first slot set and the at least one first-type length are used to determine at least one first-type slot subset from the first slot set, and a quantity of first-type symbols included in any slot in the first slot set and the second length are used to determine a second slot subset from the first slot set, where the first-type symbols include at least uplink symbols; Any first-type slot subset in the at least one first-type slot subset is used to determine a time-domain resource occupied by at least one resource pool in the plurality of resource pools, and the second slot subset is used to determine a time-domain resource occupied by at least one resource pool in the plurality of resource pools; The first time-frequency resource block belongs to a first resource pool, the first resource pool is one of the plurality of resource pools, the first slot subset is one of the at least one first-type slot subset, the first slot subset is used to determine a time-domain resource occupied by the first resource pool, and the first length is a first-type length in the at least one first-type length used to determine the first slot subset; a quantity of symbols occupied by the target positioning reference signal in a time domain is not greater than the first length.

In one embodiment, the second slot subset is used for determining a time-domain resource occupied by a second resource pool, and the second resource pool is a resource pool of the plurality of resource pools different from the first resource pool.

In one embodiment, the target positioning reference signal is used for sidelink positioning.

In one embodiment, a number of symbols occupied by the target positioning reference signal in a time domain is equal to the first length.

In one embodiment, the first length is not equal to the second length.

In one embodiment, the at least one first-type length and at least one first-type bitmap are jointly used to determine the at least one first-type time slot subset.

In one embodiment, a first bitmap is one of the at least one first-type bitmap, a first candidate slot is any slot in the first slot set, and a quantity of first-type symbols included in the first candidate slot is jointly used to determine whether the first candidate slot belongs to the first slot subset.

In one embodiment, the first time-frequency resource block is determined by the first node from the first resource pool.

In one embodiment, the first time-frequency resource block is specified by one downlink signaling from the first resource pool.

In one embodiment, the third receiver 1002 receives first configuration information, wherein the first configuration information is used to configure the at least one first-type length of the first bandwidth part.

In one embodiment, the third receiver 1002 receives second configuration information, wherein the second configuration information is used to configure the plurality of resource pools.

In one embodiment, the third receiver 1002 receives first control information on a second time-frequency resource block, wherein the first control information is used to indicate the first time-frequency resource block, the second time-frequency resource block belongs to the first resource pool, or the second time-frequency resource block belongs to the second resource pool.

In one embodiment, the second node 1000 is a user equipment.

In one embodiment, the second node 1000 is a relay node.

In one embodiment, the second node 1000 is a base station device.

A person of ordinary skill in the art may understand that all or some of the steps in the foregoing method may be completed by instructing related hardware through a program, and the program may be stored in a computer-readable storage medium, for example, a read-only memory, a hard disk, or an optical disk. Optionally, all or some of the steps in the foregoing embodiments may also be implemented by using one or more integrated circuits. Correspondingly, each module unit in the foregoing embodiments may be implemented in a form of hardware, or may be implemented in a form of a software functional module, and the present application is not limited to any specific form of combination of software and hardware. The first node device in this application includes, but is not limited to, a mobile phone, a tablet computer, a notebook, an upper network card, a low-power-consumption device, an eMTC device, an NB-IoT device, a vehicle-mounted communication device, an aircraft, an aircraft, an unmanned aerial vehicle, a remote control aircraft, and other wireless communication devices. The second node device in this application includes, but is not limited to, a mobile phone, a tablet computer, a notebook, an upper network card, a low-power-consumption device, an eMTC device, an NB-IoT device, a vehicle-mounted communication device, an aircraft, an aircraft, an unmanned aerial vehicle, a remote control aircraft, and other wireless communication devices. The user equipment or the UE or the terminal in this application includes but is not limited to a mobile phone, a tablet computer, a notebook, an upper network card, a low-power-consumption device, an eMTC device, an NB-IOT device, a vehicle-mounted communication device, an aircraft, an aircraft, an unmanned aerial vehicle, a remote control aircraft, and other wireless communication devices. The base station device or the base station or the network side device in the present disclosure includes, but is not limited to, a macro cell base station, a micro-cellular base station, a home base station, a relay base station, an EAVE, a graceful, a transmission receiving node TRP, a GNSS, a relay satellite, a satellite base station, an air base station, and other wireless communication devices.

The above are only preferred embodiments of the present disclosure and are not intended to limit the scope of protection of the present disclosure. Any modifications, equivalent replacements, improvements and the like made within the spirit and principle of the present disclosure shall fall within the protection scope of the present disclosure.

1. A first node for wireless communication, comprising:
a first transmitter, configured to send a target positioning reference signal on a first time-frequency resource block; and
a first bandwidth component configured with at least one first-type length and a second length; the first bandwidth component includes frequency domain resources occupied by a plurality of resource pools, and any one of the plurality of resource pools includes at least one slot in a time domain; the first slot set includes a plurality of slots, a quantity of first-type symbols included in any slot in the first slot set and the at least one first-type length are used to determine at least one first-type slot subset from the first slot set, and a quantity of first-type symbols included in any slot in the first slot set and the second length are used to determine a second slot subset from the first slot set, where the first-type symbols include at least uplink symbols; any first-type slot subset in the at least one first-type slot subset is used to determine a time-domain resource occupied by at least one resource pool in the plurality of resource pools, and the second slot subset is used to determine a time-domain resource occupied by at least one resource pool in the plurality of resource pools; the first time-frequency resource block belongs to a first resource pool, the first resource pool is one of the plurality of resource pools, the first slot subset is one of the at least one first-type slot subset, the first slot subset is used to determine a time-domain resource occupied by the first resource pool, and the first length is a first-type length in the at least one first-type length used to determine the first slot subset; a quantity of symbols occupied by the target positioning reference signal in a time domain is not greater than the first length.

2. The first node according to claim 1, wherein the second slot subset is used to determine a time domain resource occupied by a second resource pool, and the second resource pool is a resource pool of the plurality of resource pools different from the first resource pool.

3. The first node according to claim 1, wherein the target positioning reference signal is used for sidelink positioning (SL positioning).

4. The first node according to claim 3, wherein a quantity of symbols occupied by the target positioning reference signal in a time domain is equal to the first length.

5. The first node according to claim 4, wherein the first length is not equal to the second length.

6. The first node according to claim 5, wherein the at least one first-type length and the at least one first-type bitmap are jointly used to determine the at least one first-type time slot subset.

7. The first node according to claim 6, wherein the first bitmap is one of the at least one first-type bitmap, the first candidate slot is any slot in the first slot set, and the number of first-type symbols included in the first candidate slot is jointly used to determine whether the first candidate slot belongs to the first slot subset.

8. The first node according to claim 7, wherein the first time-frequency resource block is determined by the first node from the first resource pool.

9. The first node according to claim 7, wherein the first time-frequency resource block is specified by one piece of downlink signaling from the first resource pool.

10. The first node according to claim 9, further comprising:
a first receiver, configured to receive first configuration information;
the first configuration information is used to configure the at least one first-type length of the first bandwidth component.

11. The first node according to claim 10, further comprising:
a first receiver, configured to receive second configuration information;
the second configuration information is used to configure the plurality of resource pools.

12. The first node according to claim 11, further comprising:
a second transmitter, configured to send first control information on a second time-frequency resource block; and
the first control information is used to indicate the first time-frequency resource block, the second time-frequency resource block belongs to the first resource pool, or the second time-frequency resource block belongs to the second resource pool.

13. A second node for wireless communication, comprising:
a second receiver, configured to receive a target positioning reference signal on a first time-frequency resource block; and
a first bandwidth component configured with at least one first-type length and a second length; the first bandwidth component includes frequency domain resources occupied by a plurality of resource pools, and any one of the plurality of resource pools includes at least one slot in a time domain; the first slot set includes a plurality of slots, a quantity of first-type symbols included in any slot in the first slot set and the at least one first-type length are used to determine at least one first-type slot subset from the first slot set, and a quantity of first-type symbols included in any slot in the first slot set and the second length are used to determine a second slot subset from the first slot set, where the first-type symbols include at least uplink symbols; any first-type slot subset in the at least one first-type slot subset is used to determine a time-domain resource occupied by at least one resource pool in the plurality of resource pools, and the second slot subset is used to determine a time-domain resource occupied by at least one resource pool in the plurality of resource pools; the first time-frequency resource block belongs to a first resource pool, the first resource pool is one of the plurality of resource pools, the first slot subset is one of the at least one first-type slot subset, the first slot subset is used to determine a time-domain resource occupied by the first resource pool, and the first length is a first-type length in the at least one first-type length used to determine the first slot subset; a quantity of symbols occupied by the target positioning reference signal in a time domain is not greater than the first length.

14. A method in a first node for wireless communication, comprising:
sending a target positioning reference signal on a first time-frequency resource block; and
a first bandwidth component configured with at least one first-type length and a second length; The first bandwidth component includes frequency domain resources occupied by a plurality of resource pools, and any one of the plurality of resource pools includes at least one slot in a time domain; the first slot set includes a plurality of slots, a quantity of first-type symbols included in any slot in the first slot set and the at least one first-type length are used to determine at least one first-type slot subset from the first slot set, and a quantity of first-type symbols included in any slot in the first slot set and the second length are used to determine a second slot subset from the first slot set, where the first-type symbols include at least uplink symbols; any first-type slot subset in the at least one first-type slot subset is used to determine a time-domain resource occupied by at least one resource pool in the plurality of resource pools, and the second slot subset is used to determine a time-domain resource occupied by at least one resource pool in the plurality of resource pools; the first time-frequency resource block belongs to a first resource pool, the first resource pool is one of the plurality of resource pools, the first slot subset is one of the at least one first-type slot subset, the first slot subset is used to determine a time-domain resource occupied by the first resource pool, and the first length is a first-type length in the at least one first-type length used to determine the target slot subset; a quantity of symbols occupied by the target positioning reference signal in a time domain is not greater than the first length.

15. (canceled)
